(19) United States
(12) Patent Application Publication
(10) Pub. No.: US 2023/0369594 A1
(43) Pub. Date: Nov. 16, 2023

(54) PRIMARY AND SECONDARY SODIUM AND LITHIUM BATTERIES

(71) Applicant: The Board of Trustees of the Leland Stanford Junior University, Stanford, CA (US)

(72) Inventors: Hongjie DAI, Stanford, CA (US); Guanzhou ZHU, Stanford, CA (US); Yuanyao LI, Stanford, CA (US)

(73) Assignee: The Board of Trustees of the Leland Stanford Junior University, Stanford, CA (US)

(21) Appl. No.: 18/246,654

(22) PCT Filed: Sep. 24, 2021
(86) PCT No.: PCT/US2021/052069

§ 371 Date: Mar. 24, 2023

Related U.S. Application Data
(60) Provisional application No. 63/083,633, filed on Sep. 25, 2020.

(51) Int. Cl. H01M 4/587; H01M 4/38; H01M 10/0525; H01M 10/054; H01M 10/0563; H01M 4/133; H01M 4/66; H01M 4/62; C01B 32/15; H01G 11/50; H01G 11/52; H01G 11/62; H01G 11/36; H01G 11/84

(52) U.S. Cl. CPC H01M 4/587; H01M 4/382; H01M 4/381; H01M 10/0525; H01M 10/054; H01M 10/0563; H01M 4/133; H01M 4/661; H01M 4/669; H01M 4/623; C01B 32/15; H01G 11/50; H01G 11/52; H01G 11/62; H01G 11/36; H01G 11/84; H01M 2004/027

(57) ABSTRACT

An electrochemical device includes an anode having sodium or lithium; a cathode having a carbonaceous material; a separator; and an electrolyte that includes a metal halide, a fluorinated electrolyte compound, and thionyl chloride; wherein the electrochemical device is a primary battery or a secondary battery.

### CROSS-REFERENCE TO RELATED APPLICATIONS

This application claims the benefit of priority to U.S. Provisional Patent Application No. 63/083,633 filed Sep. 25, 2020, which is hereby incorporated by reference, in its entirety for any and all purposes.

### TECHNICAL FIELD

The present disclosure generally relates to an electrochemical device that includes an anode having sodium or lithium; a cathode having a carbonaceous material; a separator; and an electrolyte having a metal halide and thionyl chloride; wherein the electrochemical device is a primary battery or a secondary battery.

### SUMMARY

In one aspect, disclosed herein is an electrochemical device including an anode including sodium or lithium, a cathode including a carbonaceous material, a separator, and an electrolyte including a metal halide, a fluorinated electrolyte compound, and thionyl chloride, wherein the electrochemical device is a secondary battery.

In some embodiments, the metal halide is AlCl₃, NaCl₁, LiCl₁, GaCl₃, or a mixture of any two or more thereof

In some embodiments, the carbonaceous material is elected from the group consisting of amorphous carbon nanospheres, acetylene black, Ketjenblack, activated carbon, graphene, nanographene, graphene oxide, reduced graphene oxide, carbon foam, carbon fibers, graphite particles, nano-graphite particles, or a combination of any two or more thereof. In some embodiments, the carbonaceous material is produced from heat-treating the carbonaceous material in the presence of CO₂ gas, water vapor, oxygen, air, or a combination of any two or more thereof. In some embodiment, heating the solid is in the presence of CO₂ gas. In some embodiments, the heat-treating is conducted at a temperature of at least 500° C., preferably 500 to 1100° C. In some embodiments, the heating is about 0.1 to 2 hours.

In some embodiments, the carbonaceous material has a surface area of about 1000 m²/g to about 4000 m²/g, and a porosity of about 0.5-6 cm³/g. In some embodiments, the carbonaceous material has a microporosity of at least 0.5 cm³/g, preferably at least 1 cm³/g. In some embodiment, the carbonaceous material has a microporosity of 1-2 cm³/g.

In some embodiments, the carbonaceous material is packed on a substrate of Ni or stainless steel foil or foam with or without a PTFE polymer binder.

In some embodiments, the electrolyte includes up to about 10 wt % of the fluorinated electrolyte compound. In some embodiments, the fluorinated electrolyte compound includes an ammonium, alkyl ammonium, or alkali metal salt of a bis(oxalato)borate, dihalo(oxalate)borate, bis(fluorosulfonyl)imide, bis(trifluoromethane)sulfonimide, or a combination of any two or more thereof.

In some embodiments, the anode includes sodium. In some embodiments, the electrolyte includes about 0.5 M to about 6 M AlCl₃ and 0 M to about 6 M NaCl in thionyl chloride. In some embodiments, the electrolyte includes about 0.5 M to about 6 M GaCl₃ and 0 M to about 6 M NaCl in thionyl chloride. In some embodiments, the electrolyte includes about 0 wt % to about 2 wt % sodium bis(trifluoromethane)sulfonimide, and about 0 wt % to about 8 wt % sodium bis(fluorosulfonyl)imide.

In some embodiments, the anode includes lithium. In some embodiments, the electrolyte includes about 0 M to about 6 M lithium chloride (LiCl) and about 0.5 M to about 6 M AlCl₃ in thionyl chloride. In some embodiments, the electrolyte includes about 0.5 M to about 6 M GaCl₃ and 0 M to about 6 M LiCl in thionyl chloride. In some embodiments, the electrolyte includes about 0 wt % to about 3 wt % lithium bis(fluorosulfonyl)imide.

In some embodiments, the separator includes a glass fiber paper, a quartz fiber paper, a porous glass membrane, a porous glass filter, a porous quartz membrane, a porous quartz filter, porous PTFE membranes or a combination of any two or more thereof.

In some embodiments, the carbonaceous material is microporous and not purely mesoporous or macroporous. In some embodiments, the carbonaceous material is made by a method including, reacting a block polymer having ethylene oxide and propylene oxide units with ammonia, adding an aromatic diol and formaldehyde to form a solid, and heating the solid in the presence of CO₂ gas, water vapor, low concentrations of oxygen, or a combination of any two or more thereof at a temperature sufficient to carbonize the solid. In some embodiment, heating the solid is in the presence of CO₂ gas. In some embodiments, the heating is about 0.1 to 2 hours.

In some embodiments, the secondary battery is functional at room temperature (about 25° C.) and lower temperatures. In some embodiment, the battery is functional down to about −80° C.

In another aspect, disclosed herein is a method of producing a microporous carbon material, the method including reacting a block polymer having ethylene oxide and propylene oxide units with ammonia, adding an aromatic diol and formaldehyde to form a solid, and heating the solid in the presence of CO₂ gas, water vapor, oxygen, air, or a combination of any two or more thereof at a temperature sufficient to carbonize the solid and form the microporous carbon material. In some embodiments, the temperature sufficient to carbonize the solid is at least 500° C., preferably 500° C. to 1000° C. In some embodiments, the heating is about 0.1 to 2 hours. In some embodiments, the microporous carbon material has a surface area of 1000 — 4000 m²/g, and a porosity of at least 0.5 cm³/g. In some embodiments, the microporous carbon material exhibits a microporosity of at least 0.5 cm³/g, preferably at least 1 cm³/g. In some embodiment, the microporous carbonaceous material has a microporosity of 1-2 cm³/g. In another aspect, disclosed herein is microporous carbonaceous material produced by the method. In some embodiments, the microporous carbonaceous material exhibits a microporosity of at least 0.5 cm³/g, preferably at least 1 cm³/g. In some embodiment, the microporous carbonaceous material has a microporosity of 1-2 cm³/g.

### BRIEF DESCRPTION OF THE DRAWINGS

FIGS. 1A-1E are directed to a high capacity sodium-chlorine (e.g. Na/Cl₂) battery through the first discharge. FIG. 1A. Schematic drawing of the Na/Cl₂ battery with initial electrolyte composition and SEM imaging of amorphous carbon nanosphere (aCNS) in the cathode. FIG. 1B. Tunneling electron microscope (TEM) imaging of aCNS. FIG. 1C. First discharge curve of the Na/Cl₂ battery (inset: Scanning electron microscope (SEM) imaging of aCNS after about 950 mAh/g was discharged, showing the packed carbon nanosphere). FIG. 1D. Argon normalized mass spectrometry data of as made electrolyte vs. Species in an opened battery after first discharge. FIG. 1E. X-ray diffraction (XRD) spectrum of aCNS after first discharge, unlabeled peaks were Ni current collector (inset: SEM imaging of aCNS after first discharge, with all the carbon nanosphere completely covered by NaCl).

FIGS. 2A-2H are directed to a rechargeable Na/Cl battery at different battery states through cycling. FIG. 2A. Charge-discharge curve of the battery at 500 mAh/g (150 mA/g). FIG. 2B. Atomic percentages of Na and Cl from X-ray photoelectron spectroscopy (XPS) Survey spectra recorded on the aCNS cathode after the battery was charged to different capacities (inset: SEM imaging of the cathode charged to 600 mAh/g with most of the NaCl removed and revealing the underlying carbon nanosphere). FIG. 2C. XRD spectra (normalized to Ni current collector) of aCNS cathodes when batteries in discharged state were charged to various capacities, where NaCl was increasingly oxidized/removed from the cathode. FIG. 2D. Charge-discharge curve of a Na/Cl₂ battery, with the discharge curves recorded after the battery was held at open circuit for different days in fully charged state. FIGS. 2E-2F. Percentage changes for the parameters indicated versus different battery retention times in open-circuit charged state before discharging. FIG. 2G. Charge-discharge curves (red) of a Na/Cl₂ battery recorded after discharging the battery post 5 days retention in charged state. FIG. 2H. Cycling performance of the Na/Cl₂ battery with different retention cycles at 500 mAh/g (150 mA/g), where the loading of aCNS was about 4.5 mg/cm².

FIGS. 3A-3F are directed to cycling performance of Na/Cl₂ battery at capacities up to the capacity of the first lower discharge plateau (1860 mAh/g). FIG. 3A. Na/Cl₂ battery cycling at 1500 mAh/g. The electrolyte was 4 M AlCl₃ in SOCl₂+2 wt % sodium bis(fluorosulfonyl)imide (NaFSI)+2 wt % sodium bis(trifluoromethane)sulfonimide (NaTFSI). The battery was able to cycle with CE about 95%-96%. The loading of the battery was about 3.5 mg/cm². FIG. 3B. Charge-discharge curve of Na/Cl₂ battery at 1500 mAh/g and 1860 mAh/g with 100 mA/g current. The electrolyte was 4 M AlCl₃ in SOCl₂+2 wt % NaFSI+2 wt % NaTFSI. The loading of the battery was about 3.5 mg/cm². About 1250 mAh/g capacity was contributed by NaCl/Cl₂ redox. FIG. 3C. Na is spectrum of aCNS after charging to 1860 mAh/g. A strong Na is peak corresponding to NaCl was observed. FIG. 3D. Cl 2p spectrum of aCNS after charging to 1860 mAh/g. A strong Cl 2p peak corresponding to NaCl was observed. FIG. 3E. Cycling performance of Na/Cl₂ battery when the charging capacity was 1200 mAh/g (75 mA/g and 100 mA/g). The loading of aCNS was about 2.6 mg/cm². FIG. 3F. Charge-discharge curves of a Na/Cl₂ battery when the charging capacities were varied from 375 mAh/g-1200 mAh/g (150 mA/g). The overpotential of the charge-discharge slightly decreased as the cycling capacity increased (about 350 mV for 375 mAh/g cycling vs. about 190 mV for 1200 mAh/g cycling). The battery was cycling stably at each capacity for a few cycles before the cycling capacity was increased by increasing the charging time of the battery. The electrolyte used in e, f was 4 M AlCl₃ in SOCl₂+2 wt % NaFSI+2 wt % NaTFSI.

FIGS. 4A-4E are directed to importance of stable (solid electrolyte interface) SEI on sodium anode and aCNS cathode for Na/Cl₂ and Li/Cl₂ batteries. FIG. 4A. Coulombic efficiency comparison over cycling of Na/Cl₂ batteries in 4 M AlCl₃ in SOCl₂ as electrolytes with different additives indicated. FIG. 4B. Coulombic efficiency comparison over cycling of Na/Cl₂ batteries using different amounts of NaFSI/NaTFSI as additives. FIG. 4C. Coulombic efficiency comparison over cycling of Na/Cl₂ batteries using different carbon materials as the positive electrode. The cycling capacity in a-c was 500 mAh/g with about 4.5 mg/cm² aCNS loading. FIG. 4D. Typical charge-discharge curve of Li/Cl₂ battery at 500 mAh/g (black curve), 900 mAh/g (red curve) and 1200 mAh/g (green curve), 100 mA/g. The electrolyte used was 1.8 M AlCl₃ in SOC12+2 wt % LiFSI+2 wt % LiTFSI. FIG. 4E. Cycling performance of Li/Cl₂ battery at 500 mAh/g-1200 mAh/g (100 mA/g) using aCNS as the cathode and 1.8 M AlCl₃ in SOCl₂+2 wt % LiFSI+2 wt % LiTFSI as the electrolyte. The loading of aCNS in e, f was about 4.5 mg/cm².

FIGS. 5A-5B are directed to TEM and (X-ray diffraction) XRD characterizations of aCNS. FIG. 5A. Selected-area electron diffraction (SAED) pattern of aCNS. FIG. 5B. XRD spectrum of aCNS. These results showed amorphous nature of the carbon nanospheres.

FIGS. 6A-6B are directed to mass spectrum analysis and raw data showing the peak at m/z 32 134. FIG. 6A. Percentage change of the mass spectrum intensity of Cl₂ and SCl₂ in charged and dischargedbattery compared to their respective fragmented intensity. By taking the mass spectrum of pure electrolyte, pure SO₂Cl₂ and pure S₂Cl₂, the intensity ratio between Cl₂ and SOCl₂, Cl₂ and SO2C12,Cl₂ and S₂Cl₂ could be determined, respectively. Similarly, the ratio between SCl₂ and SOCl₂, SC12and SO₂Cl₂, SCl₂ and S₂Cl₂ could also be calculated (FIG. 26). From these ratios, the fragmented intensity of either Cl₂ or SCl₂, the intensity of Cl₂ or SCl₂ contributed by fragmentations of SOCl₂, S₂Cl₂ and SO₂Cl₂, could be calculated in the actual opened battery spectrum. Afterward, the percent difference between the actual intensity of Cl₂ or SCl₂ and its fragmented intensity could be calculated and were reported in this figure. See Example 14 for detailed analysis. FIG. 6B. Ar normalized mass spectrometry data of the species in battery at different battery states (after firstdischarge, no retention, 1 day retention, 3 days retention, 5 days retention and discharged). See Example 14 for detailed analysis.

FIGS. 7A-7B are directed to Na/Cl₂ battery rate performance. FIG. 7A. Cycling data when both the charging and discharging currents were varied from 50 mA/g (0.1 C) to 600 mA/g (1.2 C). The battery exhibited excellent rate capability in the 50-600 mA/g current range. FIG. 7B. Small increases in charge-discharge polarization voltage were observed at higher rates. The loading of aCNS for this battery was about 3 mg/cm². In general, higher rate beyond 1.2 C can be achieved by Na/Cl₂ batteries but at the price of reduced cycle life since high current conditions would be much more demanding on Na anode stability. Fast discharge can also be done but cycling life would be shortened.

FIGS. 8A-8D are directed to battery performance of Na/Cl₂ battery when the discharge cutoff voltage was set to 0.1 V. FIG. 8A. First discharge curve of Na/Cl₂ battery at 0.1 V cutoff voltage. FIG. 8B. Battery cycling at 500 mAh/g, 150 mA/g with one cycle discharging to 0.1 V for every 10 cycles. The loading of aCNS was about 4.5 mg/cm². FIG. 8C. Charge-discharge curves of the cycles in which the discharge cutoff voltage was 0.1 V. FIG. 8D. Battery cycling at 500 mAh/g, 150 mA/g with every cycle discharged to 0.1 V. The loading of aCNS was about 2.6 mg/cm². The electrolyte was 4 M AlCl₃ in SOCl₂+2 wt % NaFSI+2 wt % NaTFSI. This data showed that the Na/Cl₂ battery cycling stability when discharged almost fully to 0.1 V was similar to that when discharged to 2.0 V.

FIG. 9 is directed to Charge-discharge curves of Na/Cl₂ batteries when three different carbon materials acetylene black (“AB”), Ketjenblack (“KJ”), and aCNS were used as the positive electrodes respectively. All batteries were left standing in open-circuit in charged state for 5 days before discharging. Battery using aCNS as the positive electrode was able to retain the 3.55 V plateau (Cl₂ reduction) the best. Battery using KJ as the positive electrode had less obvious 3.55 V plateau and battery using AB as the positive electrode almost had all its 3.55 V plateau disappeared. This trend suggested that aCNS, with its abundance of micropore, was the most efficient in trapping Cl₂ and slow down Cl₂ from migrating into the electrolyte and reacting with the Na anode, giving the battery the best cycling performance.

FIGS. 10A-10H are directed to argon normalized mass spectrum of standard solutions and species inside battery at different states (FIG. 10A) fresh electrolyte (FIG. 10B) fresh S₂Cl₂ (FIG. 10C) fresh SO₂Cl₂ (FIG. 10D) species in charged battery with no retention (FIG. 10E) species in charged battery retained for 24 hours at open-circuit (FIG. 10F) mass spectrum of species in charged battery retained for 72 hours at open-circuit (FIG. 10G) mass spectrum of species in charged battery retained for 120 hours at open-circuit (FIG. 10H) mass spectrum of species in discharged battery. See Example 14 for detailed analysis.

FIG. 11 is directed to typical charge-discharge curve of Na/Cl₂ battery with capacity and equation labeled for each plateau. The main charging (about 3.83 V, about 430 mAh/g) and discharging (about 3.55 V, about 430 mAh/g) plateaus corresponded to the NaCl oxidation and Cl₂ reduction, respectively (eq. 8, 16 in Example 15.). The small charging plateau towards the end (about3.91 V, about 70 mAh/g) corresponded to the SOCl₂ and S oxidation, forming Cl₂, SCl₂, S₂Cl₂, SO₂Cl₂(eq. 9-13 in Example 15.). The higher discharging plateau at the beginning of discharge (about 3.69 V, about 20 mAh/g) corresponded to the reductions of SCl₂ and S₂Cl₂ (eq. 14, 15 in Example 15.). The lower discharging plateau towards the end of discharge (about 50 mAh/g, eq. 17 in Example 15.)correspond to the reduction of SO₂Cl₂ (eq. 17 in Example 15.).

FIGS. 12A-12D are directed to SEM images of aCNS at different capacities through the first discharge of Na/Cl₂ battery. FIG. 12A. SEM image of aCNS when about 950 mAh/g was discharged through the first discharge. Nanospheres in aCNS could be clearly seen and no obvious NaCl coating was observed. This was because the NaCl produced up to this point was dissolved to neutralize AlCl₃ in the electrolyte. FIG. 12B. SEM image of aCNS when about 2100 mAh/g was discharged through the first discharge. Nanospheres of aCNS in certain regions were still clearly observed, suggesting that NaCl was filling the abundant pores of aCNS and not completely passivating/coating the aCNS cathode. FIG. 12C. SEM image of aCNS when the first discharge was completed. No nanosphere in aCNS could be observed and NaCl completely covered/passivated the aCNS cathode, ending the first discharge. FIG. 12D. First discharge curve of Na/Cl₂ battery with labels showing the capacity at which the three SEM images in 12A, 12B, 12C respectively were taken. Between 12A and 12C, the produced NaCl filled into the high volume of pores of aCNS.

FIGS. 13A-13C are directed to charge-discharge curve of Na/Cl₂ batteries using 4 M NaAlCl₄ in SOCl₂ as the electrolyte and XPS of aCNS charging to 3500 mAh/g. FIG. 13A. Charge-discharge curve of Na/Cl₂ battery using 4 M NaAlCl₄ in SOCl₂ as the electrolyte at 3000 mAh/g. The battery behaved poorly and unstable voltage was observed during charging. FIG. 13B. Na is spectrum of aCNS charging to 3500 mAh/g. Strong Na is peak corresponding to NaCl was observed. FIG. 13C. Cl 2p spectrum of aCNS charging to 3500 mAh/g. Strong Cl 2p peak corresponding to NaCl was observed. The electrolyte used in b, c was 4 M NaAlCl₄ in SOCl₂.

FIGS. 14A-14B are directed to SEM images of Na electrodes after cycling in batteries using different electrolytes (4 M NaAlCl₄ in SOCl₂ and 4 M AlCl₃ in SOCl₂+2 wt % NaFSI+2 wt % NaTFSI). FIG. 14A shows SEM image of Na electrode after cycling in Na/Cl₂ batteries using 4 M NaAlCl₄ in SOCl₂ as the electrolyte. FIG. 14B shows SEM image of Na electrode after cycling in 4 M AlCl₃ in SOCl₂+2 wt % NaFSI+2 wt % NaTFSI as the electrolyte.

FIGS. 15A-15C are directed to SEM images of aCNS at different battery stages. FIG. 15A. SEM images of aCNS through the first discharge (from 950 mAh/g, to 2100 mAh/g, and then full discharge) of Na/Cl₂ battery and atomic % of C, Na, and Cl at these stages measured by SEM/EDS mapping (right bar graph). As discharge continued, more and more NaCl was formed on aCNS and the discharge stopped when NaCl passivated aCNS. Some of the NaCl formed were very large in size (tens of microns). FIG. 15B. SEM images of aCNS when Na/Cl₂ battery was re-charged to different capacities (375 mAh/g, 600 mAh/g, 900 mAh/g) and the atomic % of C, Na and Cl at these stages measured by SEM/EDS mapping (right bar graph). As charging increased, more and more NaCl was removed from aCNS, exposing the nanospheres in underlying the NaCl coating. The active sites of the battery (the sites at which oxidation reactions happened) were in the gaps between NaCl micro-crystal coating that remained intact during battery operations. FIG. 15C. SEM images of aCNS when Na/Cl₂ battery was charged to 900 mAh/g then discharged to different capacities (375 mAh/g, 600 mAh/g, 900 mAh/g) and atomic % of C, Na and Cl at these stages measured by SEM/EDS mapping (right bar graph). As discharge increased, more and more NaCl formed on aCNS. When the battery was fully discharged, all the nanospheres were covered and passivated by NaCl. To take these SEM images, batteries stopping at the designated states were opened inside an Ar-filled glovebox and the electrodes were first dried under vacuum, then taken out of the glovebox and transferred into an SEM instrument for the measurements.

FIGS. 16A-16D are directed to electrochemical impedance spectroscopy (EIS) of Na/Cl₂ battery with acidic 4 M AlCl₃ in SOC12+2 wt % NaFSI+2 wt % NaTFSI as the electrolyte through its first discharge and re-charging and first discharge curve of Na/Cl₂ battery using neutral 4 M A1C13+4 M NaCl in SOCl₂ as the electrolyte. FIG. 16A. Impedance measurements at 6 points along the curve of first discharge of the battery when acidic 4 M AlCl₃ in SOC12+2 wt % NaFSI+2 wt % NaTFSI was used as the electrolyte. FIG. 16B. Charging curve of the Na/Cl₂ battery when the charging capacity was 500 mAh/g. Each spike along the curve was a point at which battery charging was stopped for EIS measurements and then allowed to continue to charge. FIG. 16C. Impedance measurements of the Na/Cl₂ battery at different charging capacities tracing the charging curve in 16B. As charging started, the impedance of the battery rapidly decreased due to removal of NaCl in the coating layer on the positive electrode. FIG. 16D. First discharge curve of Na/Cl₂ battery when neutral 4M A1C13+4M NaCl in SOCl₂ was used as the electrolyte. Only one discharge plateau was observed in neutral electrolyte case.

FIGS. 17A-17F are directed to cycling performance of Na/Cl₂ battery at different capacities. FIG. 17A. Cycling performance of a Na/Cl₂ battery at 500 mAh/g (150 mA/g). The battery was kept at open-circuit in discharged state for 2 weeks. It was found that simply aging the battery in discharged state for days could improve the battery's cycle life, likely due to the slower formation of a uniform SEI layer on the electrode. The loading of aCNS was about 4.5 mg/cm². FIG. 17B. Na/Cl₂ battery cycling at 1200 mAh/g. The electrolyte was 4 M AlCl₃ in SOC12+1 wt % NaFSI+1 wt % NaTFSI. FIG. 17C. Na/Cl₂ battery cycling at 1200 mAh/g. The electrolyte was 4 M AlCl₃ in SOC12+2 wt % NaFSI+2 wt % NaTFSI. Both of the batteries in b, c were first cycling at 500 mAh/g (150 mA/g) for 15 cycles and the cycling capacity was gradually increased to 1200 mAh/g with 150 mA/g and 100 mA/g currents. The loading of both batteries were about 2.6 mg/cm². FIG. 17D. Cycling performance of Na/Cl₂ battery as the charging current increased from 0.3 C (150 mA/g) up to 3.9 C (1950 mA/g) with 0.3 C (150 mA/g) increased for every 5 cycles. The discharge current was kept at 0.3 C (150 mA/g). The loading of aCNS was about 3 mg/cm². FIG. 17E. Cycling performance of Na/Cl₂ battery at 1200 mAh/g with charging current increased to 0.5 C (600 mA/g) and discharging current kept at 0.08 C (100 mA/g). Cycle 1-3: 0.0625 C (75 mA/g), cycle 4-5: 0.08 C (100 mA/g) for battery stabilization. The loading of the battery was about 3 mg/cm². FIG. 17F. Typical charge-discharge curves of Na/Cl₂ battery at 1200 mAh/g. Black curve: 0.5 C (600 mA/g) charging, 0.08 C (100 mA/g) discharging. Red curve: 0.08 C (100 mA/g) charging and discharging. Only a slight increase in overpotential (about 182 mV at 0.08 C vs. about 298 mV at 0.5 C) was observed. The loading of the battery was about 3 mg/cm².

FIG. 18 is directed to SEM images of aCNS after charging to 1860 mAh/g. Left image: the nanospheres in aCNS were readily observed as NaCl depositing on the surface of aCNS were oxidized. Middle and right images: NaCl microcrystals that were either loosely deposited on top of the nanospheres clusters (not inside the nanospheres) or deposited in the gaps between the aCNS clusters were not oxidizable, and could not contribute to the battery's rechargeable capacity.

FIGS. 19A-19H are directed to Na/Cl₂ battery performances when 2 wt % FEC and 2 wt % NaPF₆ were used as the electrolyte additives and XPS of sodium metal immersing in electrolytes with different additives (2 wt % NaFSI+2 wt % NaTFSI, 2 wt % NaPF6, and 2 wt % FEC) and after battery cycling. FIG. 19A. Na/Cl₂ battery cycling performance at 500 mAh/g, 150 mA/g when 4 M AlCl₃ in SOCl₂+2 wt % FEC was used as the electrolyte. The battery behaved poorly and died after cycle 9. FIG. 19B. Na/Cl₂ battery cycling performance at 1200 mAh/g, 100 mA/g when 4 M AlCl₃ in SOCl₂+2 wt % NaPF₆ was used as the electrolyte. The battery showed worse cycling performance than when 2 wt % NaFSI+2 wt % NaTFSI was used as the electrolyte additive. FIG. 19C. Atomic percentage of different elements, calculated from XPS survey spectrum, on the Na metal after immersing in 4 M AlCl₃ in SOCl₂ with different additives (2 wt % NaFSI+2 wt % NaTFSI, 2 wt % NaPF6, and 2 wt % FEC). FIG. 19D. Cl 2p spectrum of Na metal after immersing in 4 M AlCl₃ in SOCl₂ with different additives (2 wt % NaPF₆ and 2 wt % FEC). FIG. 19E. F 1s spectrum of Na metal after immersing in 4 M AlCl₃ in SOCl₂ with different additives (2 wt % NaPF₆ and 2 wt % FEC). FIG. 19F. S 2p spectrum of Na metal after immersing in 4 M AlCl₃ in SOCl₂ with different additives (2 wt % NaPF₆ and 2 wt % FEC). FIG. 19G. Atomic percentage of different elements, calculated from XPS survey spectrum, on the Na electrode after cycling in batteries using 4 M AlCl₃ in SOCl₂ with different additives (2 wt % NaFSI+2 wt % NaTFSI, 2 wt % NaPF6, and 2 wt % FEC) as the electrolyte. FIG. 19H. F 1spectrum of Na electrode after cycling in batteries using 4 M AlCl₃ in SOCl₂ with different additives (2 wt % NaPF₆ and 2 wt % FEC) as the electrolyte. The batteries using 2 wt % NaFSI+2 wt % NaTFSI and 2 wt % NaPF₆ as the electrolyte additives in g, h were stopped at cycle 21. The battery using 2 wt % FEC as the electrolyte additive was stopped at cycle 9 when the battery died.

FIGS. 20A-20H are directed to characterizations of sodium anode immersed and cycled in 4 M AlCl₃ in SOCl₂ with and without 2 wt % NaFSI/NaTFSI; and charge-discharge curves of the normal battery versus decayed battery. FIG. 20A. Atomic percentage of different elements on the Na metal when immersed in 4 M AlCl₃ in SOCl₂ with and without 2 wt % NaFSI/NaTFSI as additives. FIG. 20B. F is spectrum of Na immersed in 4 M AlCl₃ in SOCl₂ with/without additives. FIG. 20C. S 2p spectrum of Na immersed in 4 M AlCl₃ in SOCl₂ with/without additives. FIG. 20D. Cl 2p spectrum of Na immersed in 4 M AlCl₃ in SOCl₂ with/without additives. FIG. 20E. Atomic percentage of different elements on the Na metal after cycling for 21 cycles in Na/Cl₂ battery when 4 M AlCl₃ in SOCl₂ with and without 2 wt % NaFSI/NaTFSI as additives were used as the electrolyte. FIG. 20F. F is spectrum of Na cycled in Na/Cl₂ battery when 4 M AlCl₃ in SOCl₂ with/without additives were used as the electrolyte. FIG. 20G. SEM images of Na anode from actual Na/Cl₂ battery in charged state (top two images) and when lost cycling capability (bottoms two images). Note that in the case of battery without fluoride additive, the Na anode surface was coated by more densely packed NaCl particles, eventually leading to the loss of re-chargeability. FIG. 20H. Charge-discharge curves of the battery at normal state and after the battery started to decay.

FIG. 21 is directed to SEM images of Na electrodes after cycling in batteries using 4 M AlCl₃ in SOCl₂ with different additives (2 wt % NaFSI+2 wt % NaTFSI, 2 wt % NaPF6, and 2 wt % FEC) as the electrolytes. Top row: SEM images of Na electrode after cycling in battery using 4 M AlCl₃ in SOC12+2 wt % NaFSI+2 wt % NaTFSI as the electrolyte. The SEI layer contained loosely-packed, square-shaped NaCl crystals and abundant voids still present in the SEI (indicated by circles). Middle row: SEM images of Na electrode after cycling in battery using 4 M AlCl₃ in SOC12+2 wt % NaPF₆ as the electrolyte. The SEI layer contained closely-packed, square-shaped NaCl crystals that were grown on top of a uniform layer of NaCl crystals. Such morphology made ions penetrations much less efficient. Bottom row: SEM images of Na electrode after cycling in battery using 4 M AlCl₃ in SOCl₂+2 wt % FEC as the electrolyte. The SEI layer was made of very large NaCl crystals (tens of microns in size) packed together. Such morphology made ions penetrations only possible via the small cracks between these crystals and the least efficient. The batteries using 2 wt % NaFSI+2 wt % NaTFSI and 2 wt % NaPF₆ as the electrolyte additives were both stopped at cycle 21. The battery using 2 wt % FEC as the electrolyte additive was stopped at cycle 9 when the battery died.

FIGS. 22A-22F are directed to Na/Cl₂ battery cycling performance using less electrolyte (4 M AlCl₃ in SOCl₂+2 wt % NaFSI+2 wt % NaTFSI) and thinner separators down to 60 μm. FIG. 22A. Na/Cl₂ battery cycling performance at 500 mAh/g using 100 μL electrolyte with 1 layer of QR- 100 separator. The loading of the battery was about 5 mg/cm². FIG. 22B. Na/Cl₂ battery cycling performance at 500 mAh/g using 75 μL electrolyte with 1 layer of QR-100 separator. The loading of the battery was about 5 mg/cm². FIG. 22C. Na/Cl₂ battery cycling performance at 500 mAh/g using 50 μL electrolyte with 1 layer of 60 μm glass fiber separator. The loading of the battery was about 5 mg/cm². FIG. 22D. Charge- discharge curve of Na/Cl₂ battery at 500 mAh/g using 50 μL electrolyte. FIG. 22E. Na/Cl₂ battery cycling performance at 1200 mAh/g using 100 μL electrolyte with 1 layer of QR-100 separator. The loading of the battery was about 3.6 mg/cm². FIG. 22F. Charge-discharge curve of Na/Cl₂ battery at 1200 mAh/g using 100 μL electrolyte.

FIGS. 23A-23B are directed to Li/Cl₂ battery cycling at 500 mAh/g with 4 M AlCl₃ in SOCl₂+2 wt % LiFSI+2 wt % LiTFSI as the electrolyte. FIG. 23A. Cycling performance of Li/Cl₂ battery at 500 mAh/g with 150 mA/g and 100 mA/g currents (the first five cycles were cycling at 150 mA/g and starting from cycle 6 the current was 100 mA/g). The loading of the battery was about 4.5 mg/cm². FIG. 23B. Typical charge-discharge curve of Li/Cl₂ battery at 500 mAh/g cycling capacity. The loading of the battery was about 4.5 mg/cm².

FIG. 24 shows average surface area, pore volume (micropore and mesopore) of different carbon materials, and the first discharge capacity of Na/Cl₂ battery using AB, KJ and aCNS as the positive electrode. Brunauer-Emmett-Teller (BET) surface area and pore volume were measured by 2020 Accelerated Surface Area and Porosimetry System from Micromeritics. Before each measurement, the appropriate amount of carbon (about 0.14 g) was weighed and placed in the instrument for degas at 350° C. After degassing, the weight of the carbon was measured again and this weight was input into the software for final surface area and porosity analysis. In the final analysis, the evacuation time was set to be 6 hours and dose amount was set to be 10 cm³/g at standard temperature and pressure. After the measurement was done by the instrument, the surface area and porosity were reported.

FIG. 25 shows comparisons among Na/Cl₂ battery and other Na metal anode batteries reported in literature. The Na/Cl₂ battery exhibited the highest capacity (based on massof active cathode materials), and excellent cycle life. Note the Na-SO₂ battery utilized redox of SO2 on the positive electrode with a much larger polarization voltage of 1-1.5 V than about 0.2 V for the Na/Cl₂ cells. The Na/Cl₂ battery operates at higher voltages than both S and SO2, and is the first time stable cycling achieved with the highly reactive/oxidative Cl₂ molecules. The polarization voltage is very small suggesting high energy efficiency (about 92.4% when cycling at 1200 mAh/g, 150 mA/g and about 94.2% when cycling at 1200 mAh/g, 100 mA/g).

FIG. 26 shows ratios between peak intensity of different species/fragments and peak intensity of molecular peak in pure S₂Cl₂, pure SO₂Cl₂, and fresh electrolyte. See Example 14 for detailed analysis.

FIG. 27 is directed to first discharge capacity comparison between Li/Cl batteries when the positive electrode was KJ carbon and KJ carbon heat-treated in CO₂. A substantial improvement in the first discharge capacity was seen after the KJ was heat treated in CO₂.

### DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Herein provided is a sodium or lithium ion battery having a sodium (“Na”) or lithium (“Li”) anode, a carbonaceous cathode (e.g., a cathode having amorphous carbon nanospheres), and a starting electrolyte that includes a metal halide and thionyl chloride (i.e., SOCl₂). The battery exhibits ultrahigh first discharge capacity, and may cycle with a high reversible capacity. Through battery cycling, the electrolyte evolved to contain sodium or lithium chloride (i.e. NaCl or LiCl) and various sulfur and chlorine species that supported the anode Na/Na⁺ or Li/Li⁺ reduction/oxidation (“redox”) and the cathode chloride/chlorine. Fluoride-based additives (also referred to hereafter as “fluorinated electrolyte compounds”) were found to be important in forming a solid-electrolyte interface (“SEI”) on the Na or Li anode, affording reversibility of the anode for a new class of high capacity sodium or lithium ion battery.

In one aspect, the present technology provides a primary or secondary battery includes an anode that includes sodium or lithium; a cathode that includes a carbonaceous material; a separator; and an electrolyte including a metal halide, fluorinated electrolyte compound, and thionyl chloride.

Illustrative metal halides include, but are not limited to, AlCl₃, NaCl, LiCl, GaCl₃, or a mixture of any two or more thereof

Illustrative carbonaceous materials include, but are not limited to, amorphous carbon nanospheres, acetylene black (“AB”), Ketjenblack (“KJ”), activated carbon, graphene, nanographene, graphene oxide, reduced graphene oxide, carbon foam, carbon fibers, graphite particles, nano-graphite particles, or a mixture of any two or more thereof. In some embodiments, the cathode includes a carbonaceous material prepared by heat-treating the carbonaceous material in CO₂ gas, water vapor, low concentrations of oxygen, or a combination of any two or more thereof. In some embodiments, the cathode includes a carbonaceous material prepared by heat-treating the carbonaceous material in CO₂ gas. The heat-treating may be conducted at a temperature of at least 500° C. In some embodiments, the heat-treating is conducted at a temperature of at least 600° C., 700° C., 800° C., 900° C., 1000° C., or 1100° C., or from about 500° C. to about 1500C, from about 500° C. to about 1100° C., from about 600° C. to about 1500° C., from about 600° C. to about 1100° C., from about 700° C. to about 1500° C., from about 700° C. to about 1100° C., from about 800° C. to about 1500° C., from about 800° C. to about 1100° C., from about 900° C. to about 1500° C., from about 900° C. to about 1100° C., from about 1000° C. to about 1500° C., or from about 1000° C. to about 1100° C.

In some embodiments, the carbonaceous materials have a high surface area (e.g., 1000-4000 m²/g) and/or a high porosity (e.g., at least 0.5, 1, 2, or 2.5 cm³/g). As utilized herein with respect to the carbonaceous materials, the terms “micropore” or “microporosity,” and similar referents are referring to the part of the pore space that has a characteristic dimension less than 2 nm. The terms “mesopore” or “mesoporosity,” and similar referents are referring to the part of the pore space that has a characteristic dimension larger than 2 nm but less than 50 nm. The terms “macropore” or “macroporosity,” and similar referents are referring to the part of the pore space that has a characteristic dimension larger than 50 nm. In some embodiments, the carbonaceous materials in the cathode is microporous and not purely mesoporous or macroporous. In some embodiments, the cathode includes carbonaceous materials having a high microporosity (e.g., at least 0.5, 1.0, or 1.5 cm³/g). In some embodiments, the carbonaceous materials are made by a method including, reacting a block polymer having ethylene oxide and propylene oxide units with ammonia, adding an aromatic diol and formaldehyde to form a solid, and heating the solid in the presence of CO₂ gas, water vapor, low concentrations of oxygen, or a combination of any two or more thereof at a temperature sufficient to carbonize the solid.

In some embodiments, the cathode includes the carbonaceous material packed on a substrate of Ni or stainless steel foil or foam with or without a PTFE polymer binder.

In some embodiments, the cathode includes a layer of the carbonaceous material, wherein the layer of the carbonaceous material is about 30-100 nm, preferably about 50-70 nm or about 60 nm.

In some embodiments, the electrolyte may include a small percentage (e.g., 1, 2, 3, 4, 5, 6, 7, 8, 9, or 10 wt.%) of the fluorinated electrolyte compound. Illustrative fluorinated electrolytes include an ammonium, alkyl ammonium, or alkali metal salt of a fluorinated sulfonamides such as but not limited to a bis(fluorosulfonyl)imide or bis(trifluoromethane)sulfonimide, or oxalatoborates such as but not limited to bis(oxalate)borate or a dihalo(oxalato)borate, or a combination of any two or more thereof. Specific examples include, but are not limited to lithium bis(fluorosulfonyl)imide, sodium bis(fluorosulfonyl)imide, an ammonium or alkyl ammonium bis(fluorosulfonyl)imide, lithium bis(trifluoromethane)sulfonimide, sodium bis(trifluoromethane)sulfonimide, an ammonium or alkyl ammonium bis(trifluoromethane)sulfonimide, lithium bis(oxalate)borate, sodium bis(oxalate)borate, lithium difluoro(oxalato)borate, lithium difluoro(oxalato)borate, or a combination of any two or more thereof.

In some embodiments, the anode may include sodium and the electrolyte includes about 1-6 M aluminum chloride (AlCl₃) mixed with 0-6 M NaCl in thionyl chloride (SOCl₂). In some embodiments, the electrolyte includes about 1-6 M Gallium chloride (GaCl₃) mixed with 0-6 M NaCl in thionyl chloride (SOCl₂). In some embodiments, the electrolyte includes about 0-2 wt % sodium bis(trifluoromethane)sulfonimide (NaTFSI) and about 0-8 wt % sodium bis(fluorosulfonyl)imide (NaFSI).

In some embodiments, the anode may include lithium. In some embodiments, the electrolyte includes about 0-6 M lithium chloride (LiCl) and about 1-6 M AlCl₃ in thionyl chloride (SOCl₂). In some embodiments, and the electrolyte includes about 1-6 M Gallium chloride (GaCl₃) mixed with 0-6 M LiCl in thionyl chloride (SOCl₂). In some embodiments, the electrolyte includes about 0-3 wt % lithium bis(fluorosulfonyl)imide (LiFSI).

In some embodiments, the battery is functional at room temperature and lower temperatures, such as at about −20 to −30° C., about −30 to −40° C., −40 to −50° C., −50 to −60° C., −60 to −70° C., −70 to −80° C., or lower.

In some embodiments, the battery may be in the form of a coin cell battery. In such embodiments, the coin cell anode side case may be coated with polytetrafluoroethylene (“PTFE”) or be covered by a PTFE film to prevent corrosion.

Illustrative separators may include one or more of a glass fiber paper, a quartz fiber paper, a porous glass membrane, a porous glass filter, a porous quartz membrane, a porous quartz filter, a porous PTFE membrane, or a combination of any two or more thereof

In another aspect, disclosed herein is a method of producing a microporous carbon material, the method comprising reacting a block polymer having ethylene oxide and propylene oxide units with ammonia, adding an aromatic diol and formaldehyde to form a solid, and heating the solid in the presence of CO₂ gas, water vapor, low concentrations of oxygen, or a combination of any two or more thereof at a temperature sufficient to carbonize the solid and form the microporous carbon material. In some embodiments, the temperature sufficient to carbonize the solid is at least at least 500° C., 600° C., 700° C., 800° C., 900° C., 1000° C., or 1100° C., or from about 500° C. to about 1500C, from about 500° C. to about 1100° C., from about 600° C. to about 1500° C., from about 600° C. to about 1100° C., from about 700° C. to about 1500° C., from about 700° C. to about 1100° C., from about 800° C. to about 1500° C., from about 800° C. to about 1100° C., from about 900° C. to about 1500° C., from about 900° C. to about 1100° C., from about 1000° C. to about 1500° C., or from about 1000° C. to about 1100° C. In some embodiments, the heating is about 0.1-2 hours. In some embodiments, the microporous carbon materials have a surface area of 1000-4000 m²/g, and a porosity of at least 0.5 cm³/g. In some embodiments, the amorphous carbon nanospheres exhibit a microporosity of at least 0.5 cm³/g, preferably at least 1 cm³/g. In another aspect, disclosed herein are microporous carbon material sproduced by the method. In some embodiments, the microporous carbon materials exhibit a microporosity of at least 0.5 cm³/g, preferably at least 1 cm³/g.

The present invention, thus generally described, will be understood more readily by reference to the following examples, which are provided by way of illustration and are not intended to be limiting of the present invention.

### EXAMPLES

Example 1. A sodium/Cl₂ battery using amorphous carbon nanosphere (aCNS) as the cathode and AlCl₃ in SOCl₂ as the main components in the starting electrolyte. The battery operates/cycles with a 3.5 V discharge voltage and up to 1200 mAh/g (based on aCNS mass throughout this report unless otherwise specified) capacity over >200 cycles, with coulombic efficiency and energy efficiency (ratio of energy discharged over charging energy input per cycle) of >99% and >90%, respectively. The positive electrode contained a packed layer of about 60 nm high temperature CO₂ activated aCNS with a surface area of about 3168 m²/g and about 2.5 cm³/g pore volume. The battery delivered a first discharge capacity of about 2800 mAh/g with an average discharge voltage of about 3.2 V. Unexpectedly, the battery could be cycled reversibly at a specific capacity of 1200 mAh/g with a discharge voltage of about 3.55 V and an average coulombic efficiency of >99% (up to 1860 mAh/g cycling capacity with a lower coulombic efficiency). The battery's first discharge led to NaCl formation on the aCNS positive electrode resembling LiC1 in Li-SOCl₂ primary battery. The carbon micro-structure on the positive side and fluoride doped NaCl SEI on sodium were found critical to subsequent reversible battery cycling, with the redox between NaCl and Cl₂ as the dominant reaction that contributed to the main reversible capacity of the battery. The same concept also led to a rechargeable Li/Cl₂ battery.

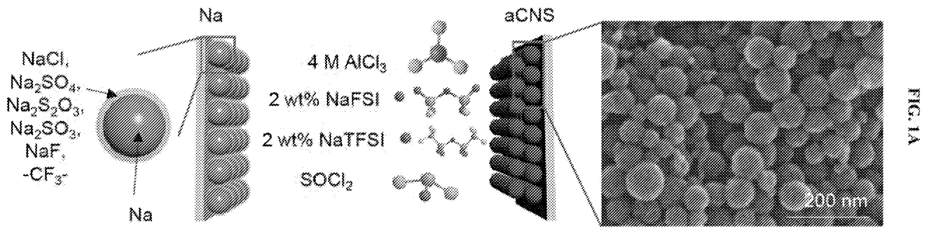

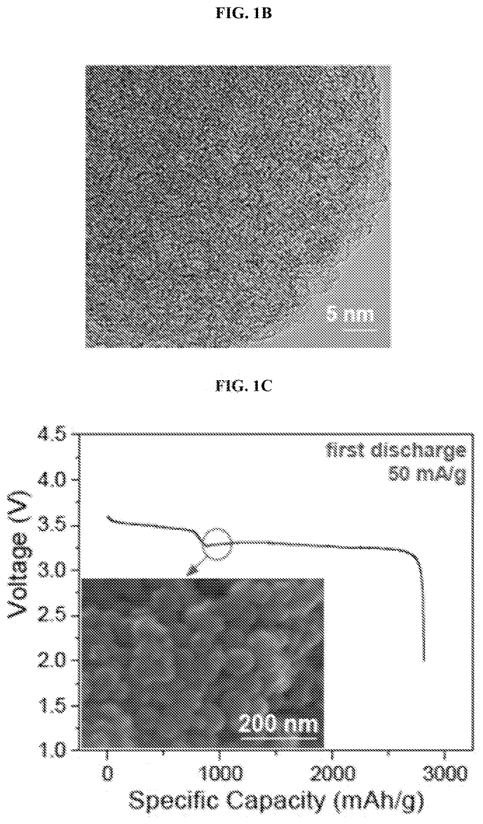

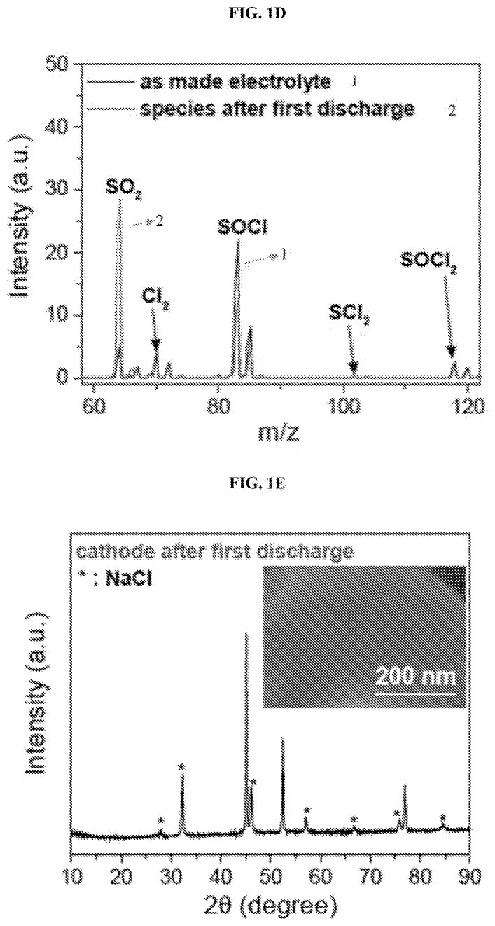

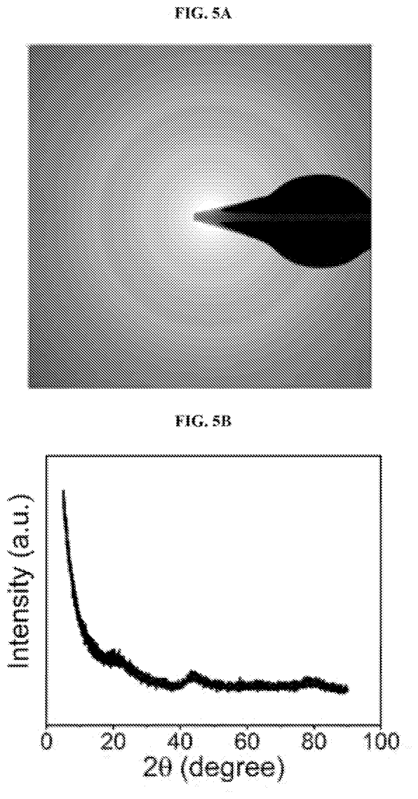

The amorphous carbon nanospheres were about 60 nm (FIG. 1A) synthesized using a modified Stöber method through polymer carbonization followed by high temperature activation in CO₂.^{26,27} The carbon nanospheres were amorphous with rich microporous structures (FIG. 1B, and FIG. 5), exhibiting a surface area of about 3168 m²/g and a high pore volume of about 2.49 cm³/g (about 53.4% micropores <2 nm; 46.6% mesopores >2 nm; FIG. 24).

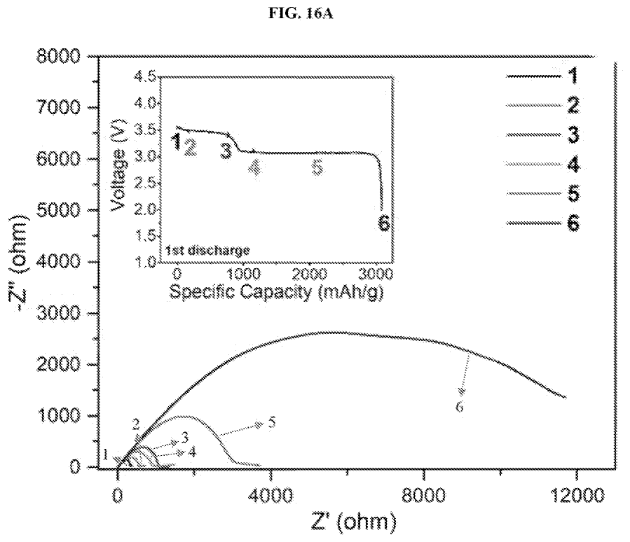

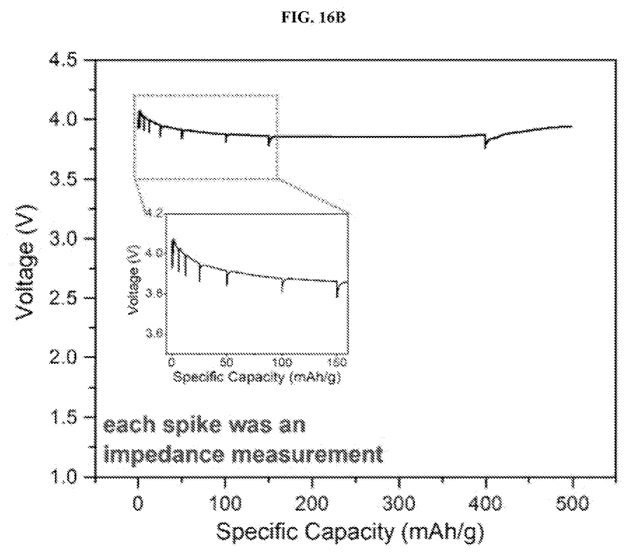

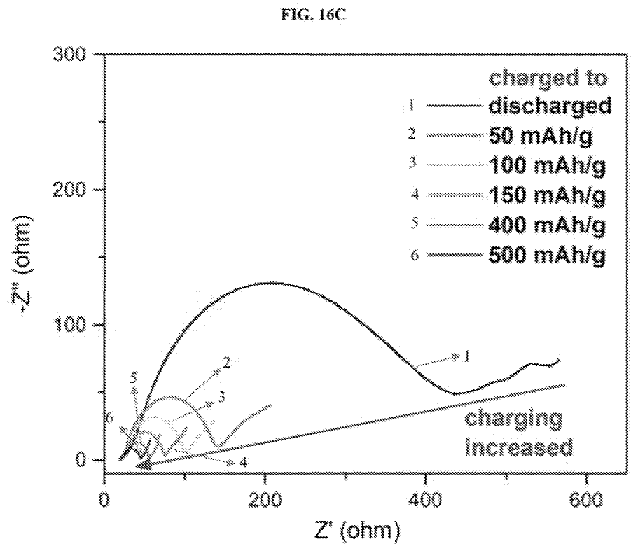

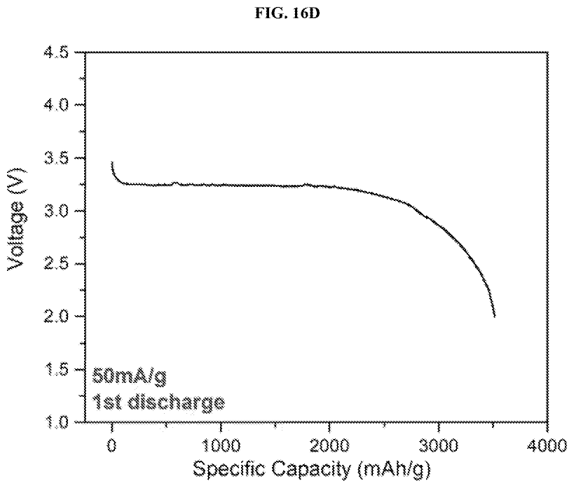

Example 2. A battery was constructed using sodium metal as the negative electrode and packed carbon nanosphere (aCNS) with PTFE binder in a Ni foam as the positive electrode in a coin cell. The starting electrolyte was 4 M AlCl₃ dissolved in SOCl₂ mixed with 2 wt % sodium bis(trifluoromethane)sulfonimide (NaTFSI) and 2 wt % sodium bis(fluorosulfonyl)imide (NaFSI) additives (FIG. 1A). The as-made battery was first discharged to 2 V, exhibiting a capacity of about 2810 mAh/g and two plateaus at about 3.47 V and 3.27 V (FIG. 1C), corresponding to Na discharge to NaCl to first neutralize the acidic electrolyte and then depositing NaCl on the aCNS electrode respectively (see Example 15). Through the second plateau the discharged NaCl deposited into the pores of aCNS in the positive electrode and on the surfaces of the nanospheres (FIG. 1E, and FIG. 15A, see Examples 15 and 16), conformed by XRD, SEM (FIG. 1E, and FIG. 15A) and a large increase in the electrochemical impedance of the cell (FIG. 16A). Mass spectrometry revealed formation of SO2 (FIG. 1D, see Example 14 for all mass-spec experiments and results in this work) highly soluble in SOCl₂ without pressurizing the cell.

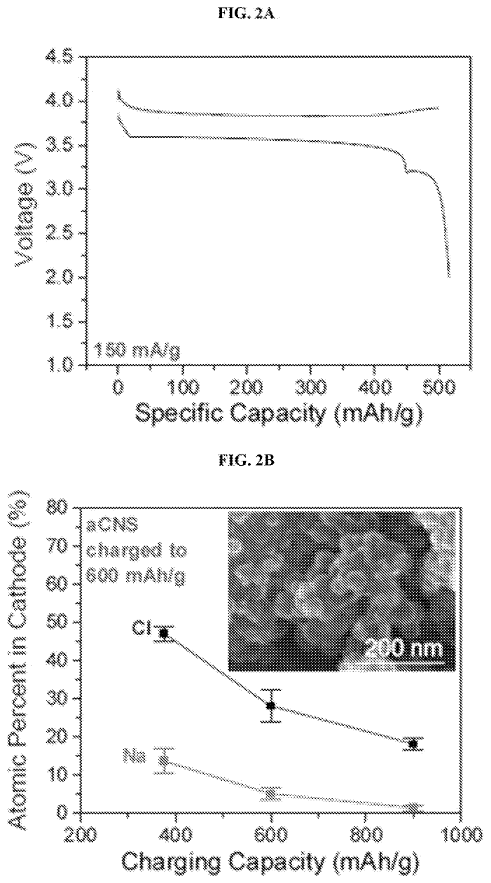

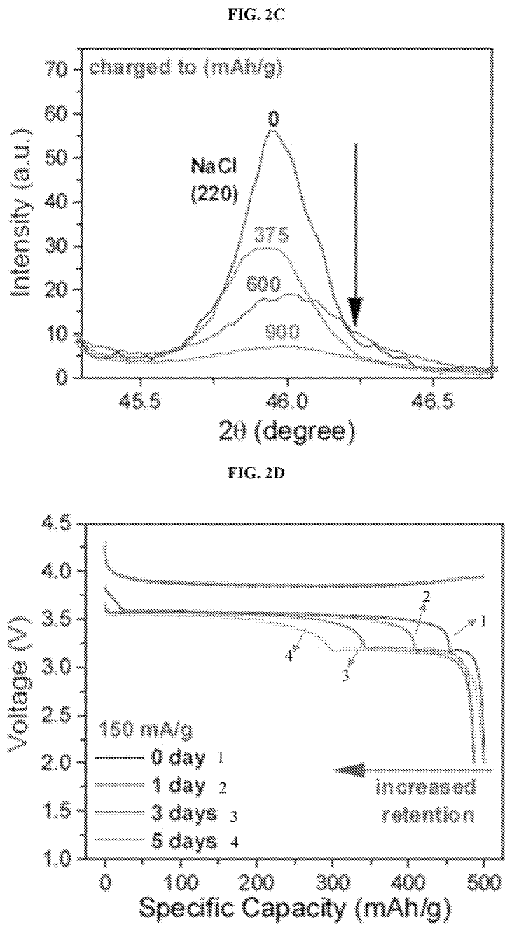

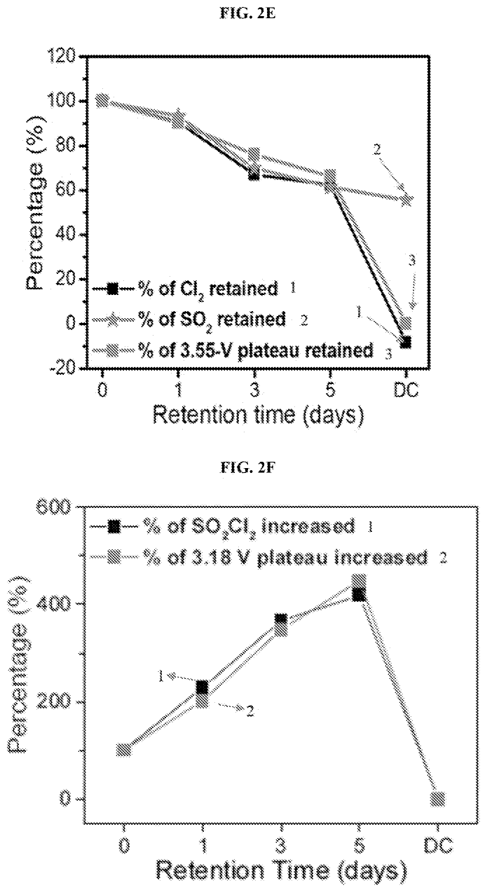

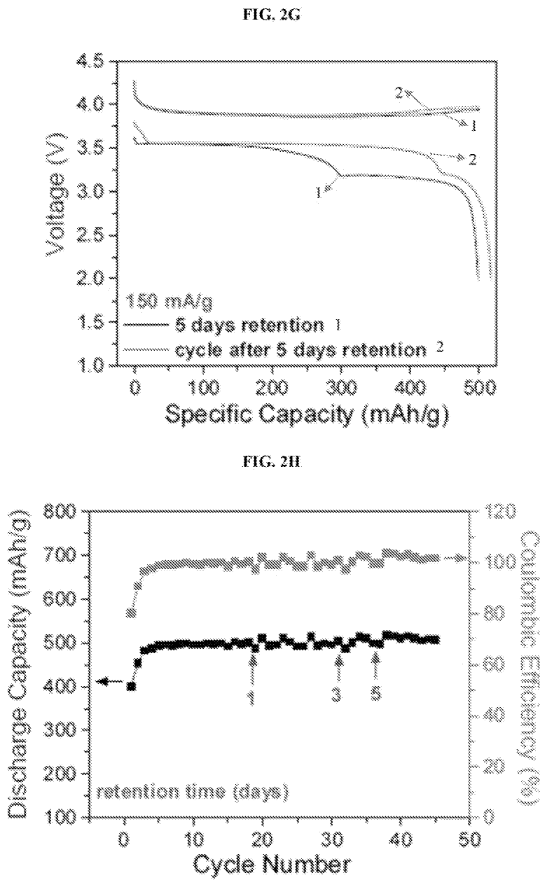

When re-charging the battery after the first discharge, Na was deposited on the Na electrode and the deposited NaCl on the aCNS electrode was oxidized (at about 3.83 V, FIG. 2A) to form Cl₂ residing in the large volume of pores in aCNS (FIG. 24). Oxidation of NaCl was confirmed by ex-situ XPS showing decreases in Na and Cl elements on aCNS (FIG. 2B), removal of NaCl crystallites on the aCNS positive electrode to expose the underlying carbon nanospheres in SEM (FIG. 2B inset and FIG. 15B), and decrease in XRD peaks of NaCl on the electrode (FIG. 2C). The charging voltage immediately spiked to about 4.16 V and then decreased to about 3.83 V, suggesting anodic removal of insulating NaCl to expose the aCNS nanospheres (FIG. 2B, FIG. 15B) accompanied by a rapid impedance decrease (FIGS. 16B-16C) to facilitate further charging/oxidation of NaCl in the pores of aCNS. SEM imaging showed exposure of aCNS in the gaps of NaCl microcrystal coating from the first discharge (FIG. 15B, indicated by square). However, not all of the surface NaCl layer was oxidizable with parts remaining regardless of the re-charging capacity. Instead of oxidizing the remaining NaCl (loosely bound to aCNS), towards the end of charging, a higher charging voltage plateau (about 3.91 V) was observed (FIG. 2A), attributed to oxidation of SOCl₂ in the electrolyte over the exposed carbon nanospheres to form SCl₂, S₂Cl₂. and SO₂Cl₂^{11,28,29}.

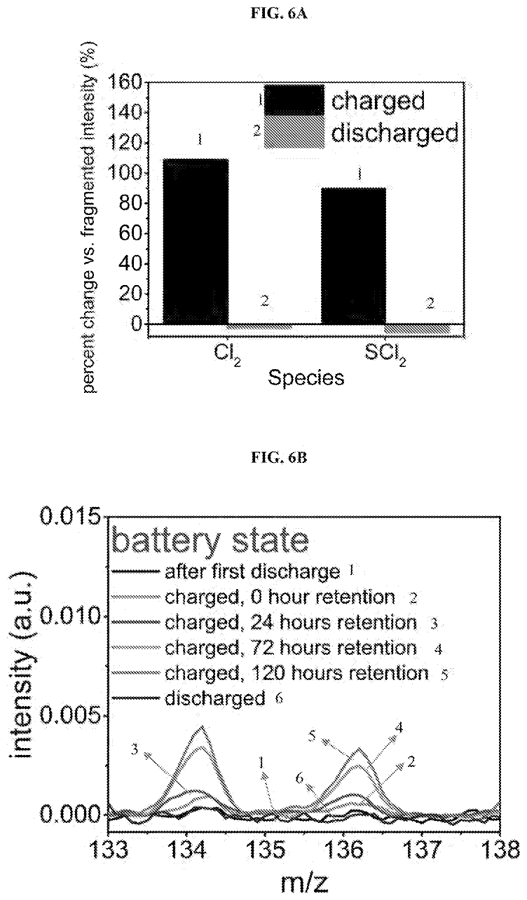

Mass-spectrometry (MS) of species in opened batteries (see Example 14) after cycling 21 times at a stable coulombic efficiency showed that the main discharge plateau of about 3.55 V was attributed to Cl₂ reduction. This was based on that the detected Cl₂ species (excluding fragments from other molecules, FIG. 6A) decreased to about 0% in fully discharged state from about 100% in charged state (see Example 14). Reduction of molecular Cl₂ species generated and trapped in aCNS contributed to the majority of the discharge capacity during cycling, responsible for the main charge/discharge 3.83 V/3.55 V plateaus with an overall battery reaction of (see Example 15):

Na+½Cl₂↔NaCl.

The two small discharge plateaus at about 3.69 V and about 3.18 V were attributed to reduction of S₂C12/SCl₂ and SO₂Cl₂ (formed at the end of the charging) respectively (FIG. 2A). When a battery was held at open-circuit in a charged state over longer times (up to 5 days), the main discharge plateau was observed at about 3.55 V decreased in capacity while the lower discharge plateau at about 3.18 V extended (FIG. 2D). Mass spectrometry showed that the detected Cl₂ in the battery decreased proportionally to the about 3.55 V plateau capacity, together with a decrease in SO₂, increase in SO₂Cl₂ and longer about 3.18 V SO₂Cl₂ discharge plateau (FIG. 2E, FIG. 2F, FIG. 6B, see Example 14). During long retention times, Cl₂ migrated to recombine with SO₂ to form SO₂Cl₂ (see Example 15), causing a decreased about 3.55 V Cl₂ reduction plateau and increased SO₂Cl₂ discharge plateau at about 3.18 V (FIG. 2D). The reduction of SO₂Cl₂ for the lower about 3.18 V discharge plateau was (see Example 15):

2 Na⁺+SO₂CL₂+2 e⁻→SO₂+2 NaCl

Open circuit holding of battery for days slowly shortened the higher discharge plateau at about 3.55 V, but battery discharge capacity was about 99.9% retained with the average discharge voltage remaining high, >3.2 V. The 3.55 V plateau was immediately restored in subsequent cycles (FIG. 2G, and FIG. 2H).

Mass spectrometry data also suggested that during battery cycling SCl₂ and S₂Cl₂ were involved in the small, highest charge (about 3.91 V, due to SOCl₂ oxidation) and discharge voltage (about 3.69 V, SCl₂ and S₂Cl₂ reduction) plateaus (FIG. 6A, see Examples 14-15). On discharge, part of the NaCl produced reacted with AlCl₄⁻·SOCl⁺ in the electrolyte to re-generate SOCl₂ oxidized in the charging step, which was important to electrolyte re-generation and the rechargeability of the Na/Cl₂ battery (see Example 15)¹¹.

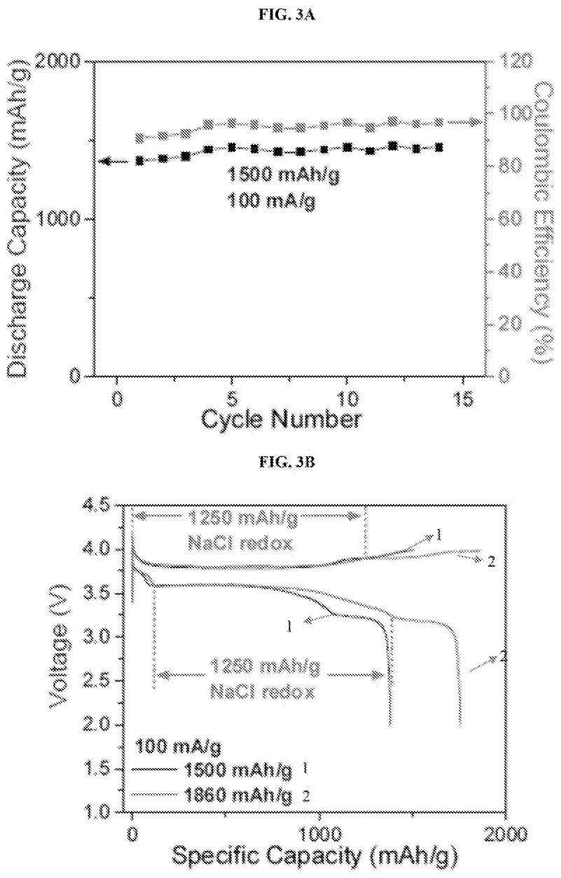

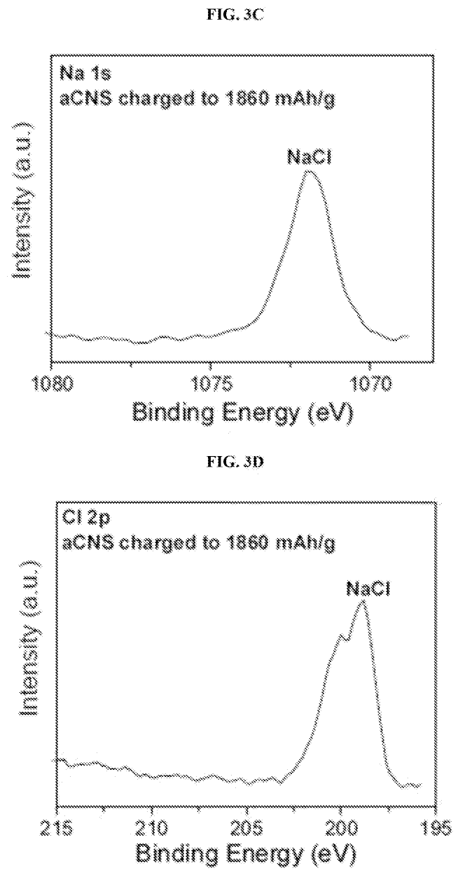

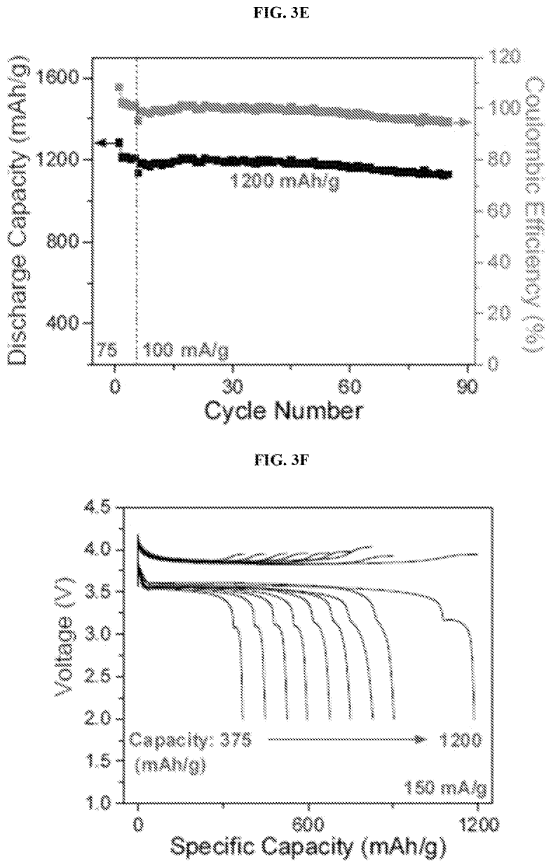

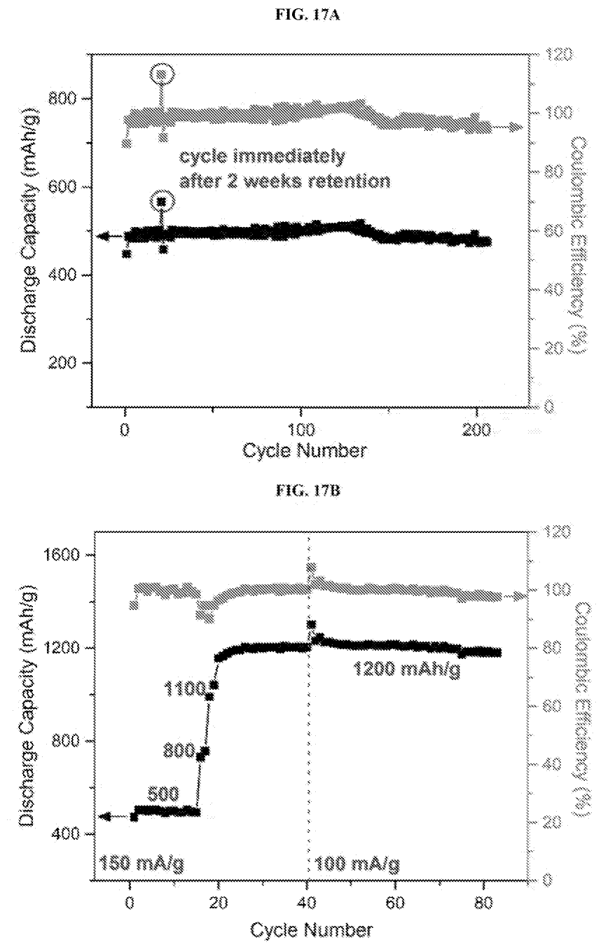

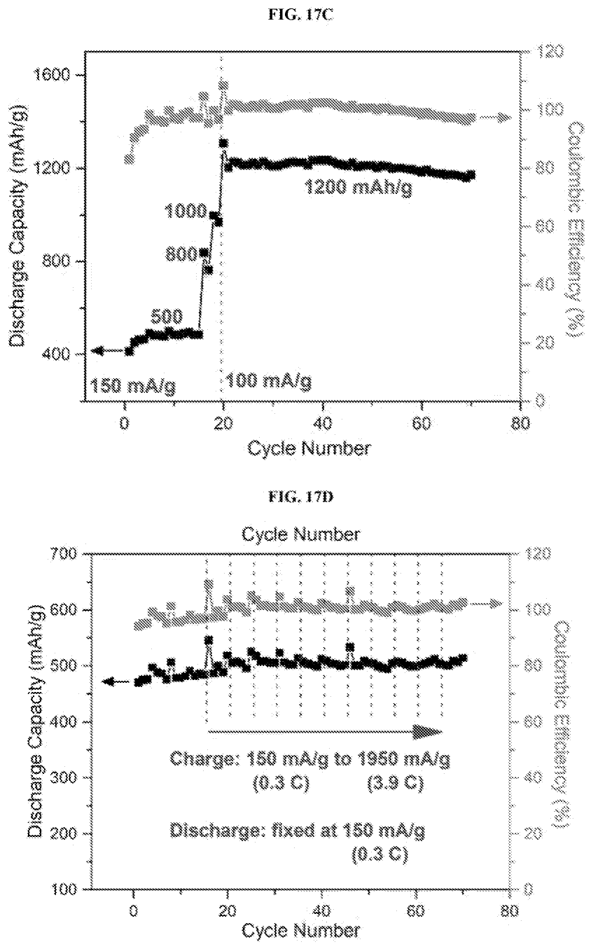

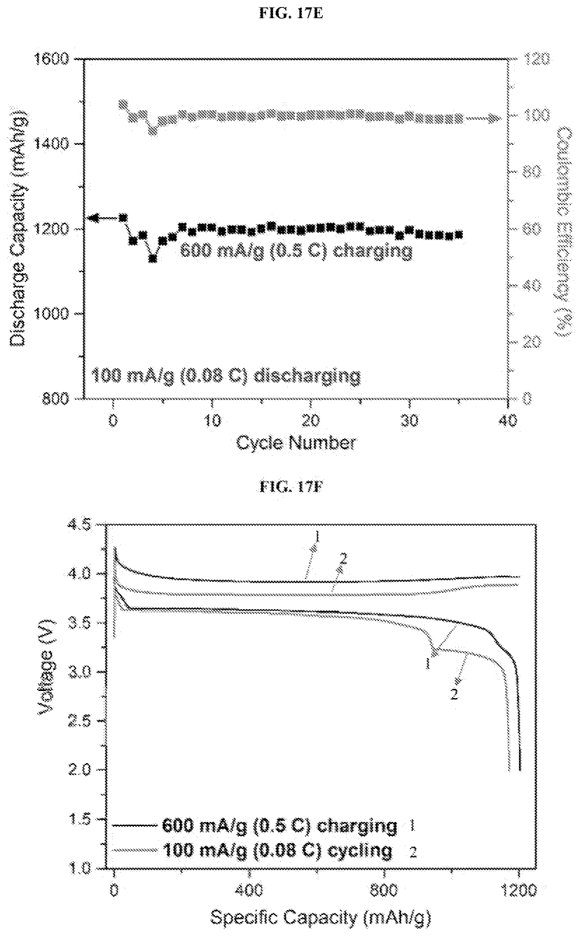

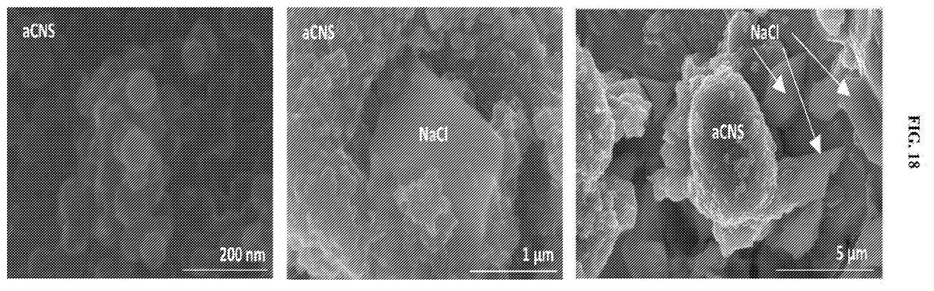

The Na/Cl₂ battery cycled for >200 cycles at a set specific capacity of 500 mAh/g at 150 mA/g current (based on aCNS mass throughout, FIG. 17A). The Na/Cl₂ batteries cycled with a discharge capacity up to about 1800 mAh/g, but at about 90% coulombic efficiency (FIGS. 3A-3B) due to non-oxidizable loosely bound NaCl microcrystals on aCNS (FIGS. 3C-3D, FIG. 18). The Na/Cl₂ battery cycled with CE >99% at a reversible capacity of about 1200 mAh/g (FIGS. 17B-17C) due to NaCl in the pores of aCNS. The charge-discharge polarization voltage decreased discernably as charging capacity increased (FIG. 3F), indicating reduced impedance as more NaCl was oxidized/removed in the pores of the carbon nanospheres. The energy efficiency of the Na/Cl₂ battery reached 92.4% (150 mA/g) and 94.2% (100 mA/g) owing to small polarizations.

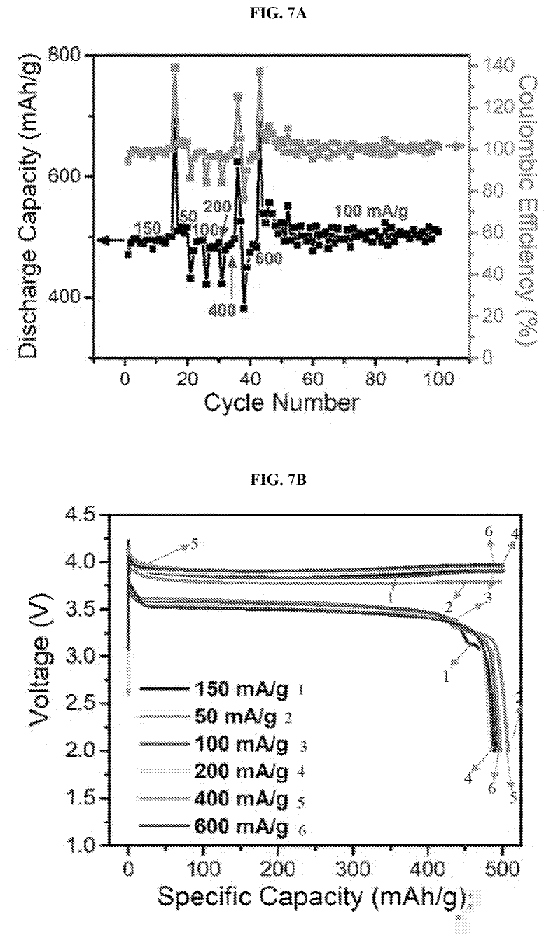

The Na/Cl₂ battery showed high cyclability at 500 mAh/g at 1.2 C rate (600 mA/g, 1.39 mA/cm² Na) (FIGS. 7A-7B). It was observed that charging could be done much faster than discharging with a charging rate up to 3.9 C at 500 mAh/g (5.63 mA/cm² Na; in about 15 min) and 0.5 C (1.39 mA/cm² Na) at 1200 mAh/g over many cycles at a high coulombic efficiency of >99%, with only a slight increase in overpotential (defined as the voltage difference between the main charging and discharging plateaus, FIGS. 17D-17F).

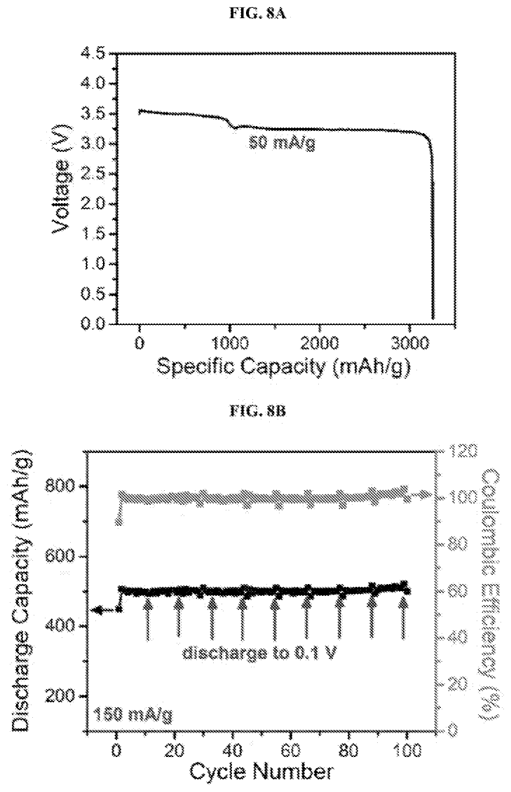

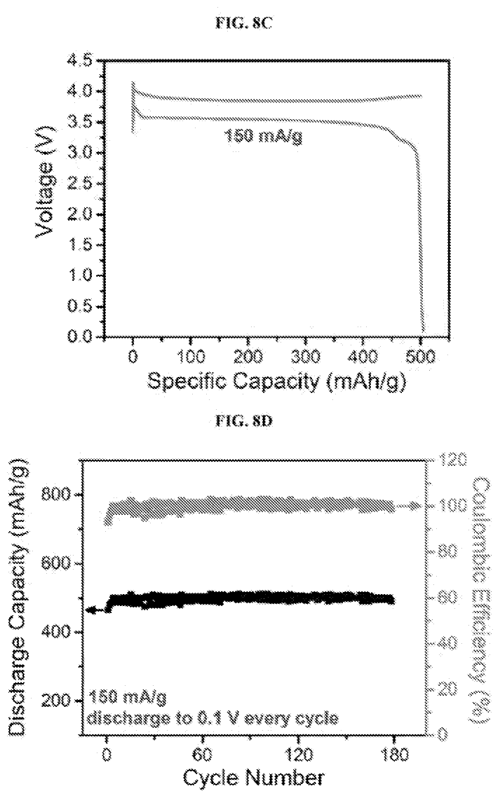

Importantly, throughout cycling of hundreds of Na/Cl₂ battery coin cells over a period of about 3 years (discharge cutoff voltage as low as 0.1 Vat room temperature), no safety problems under all battery operating conditions including discharging to various degrees were encountered (FIG. 8). No pressurizing problems were found due to strong solvation of SO₂, Cl₂ species by SOCl₂, SO₂Cl₂ and NaAlCl₄ in the electrolyte.

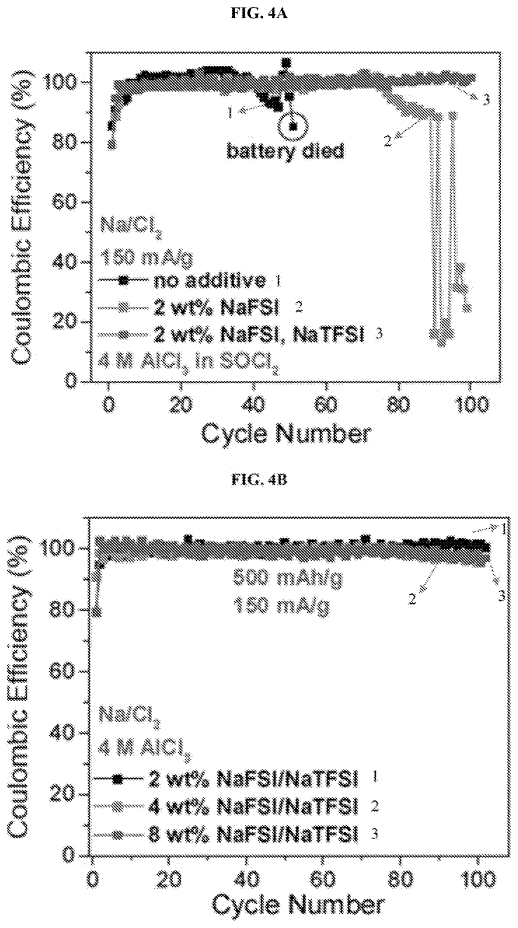

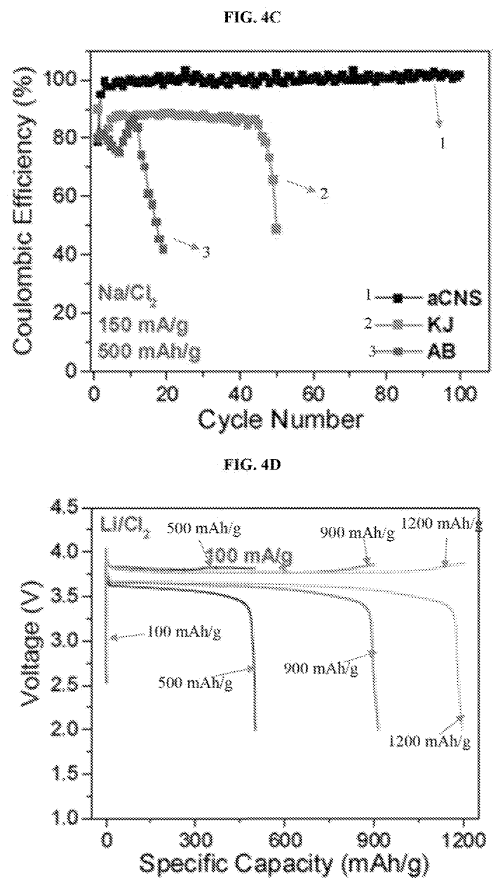

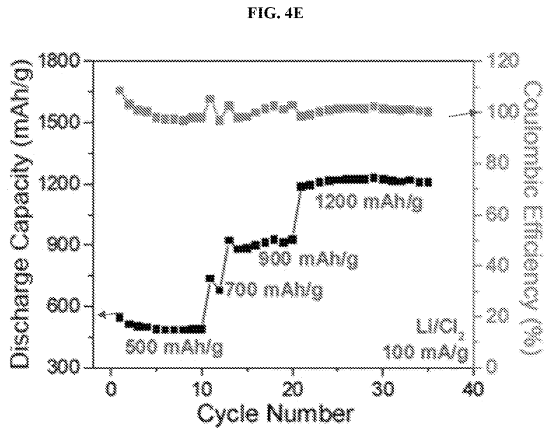

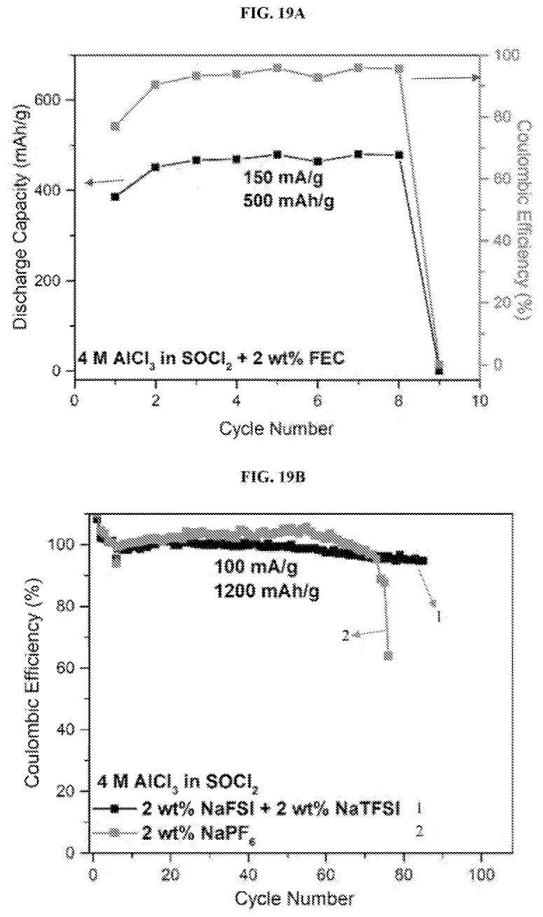

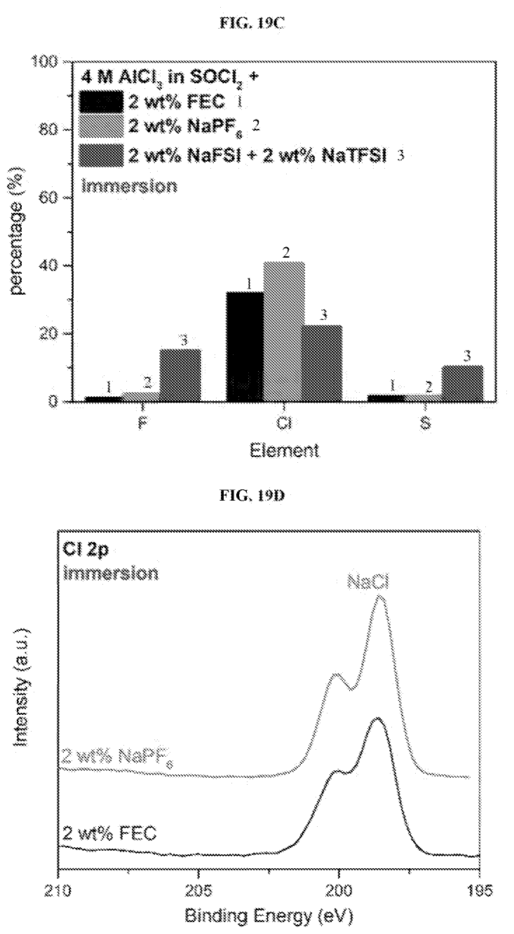

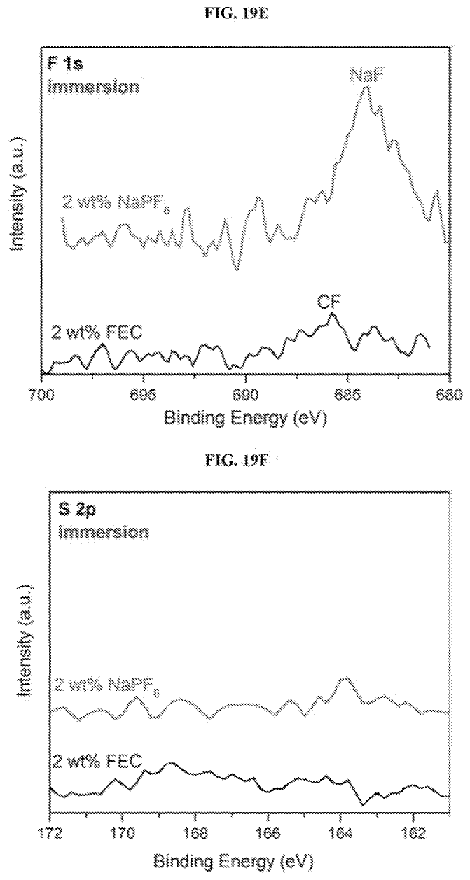

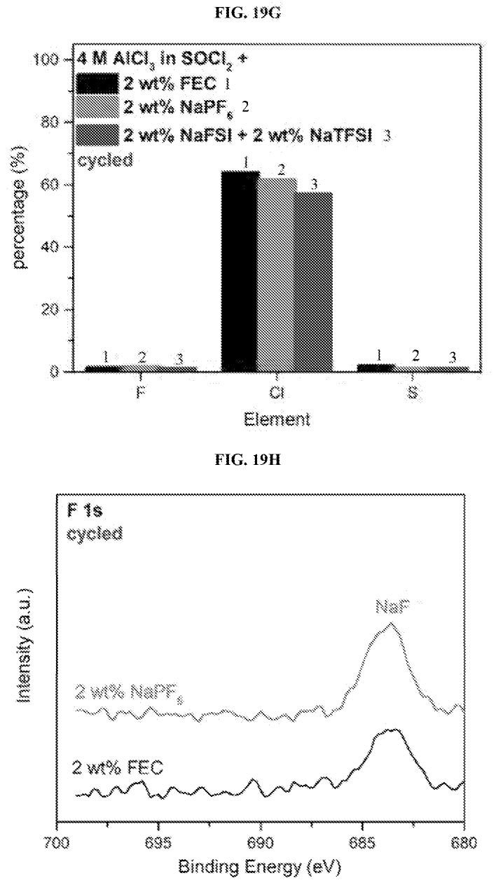

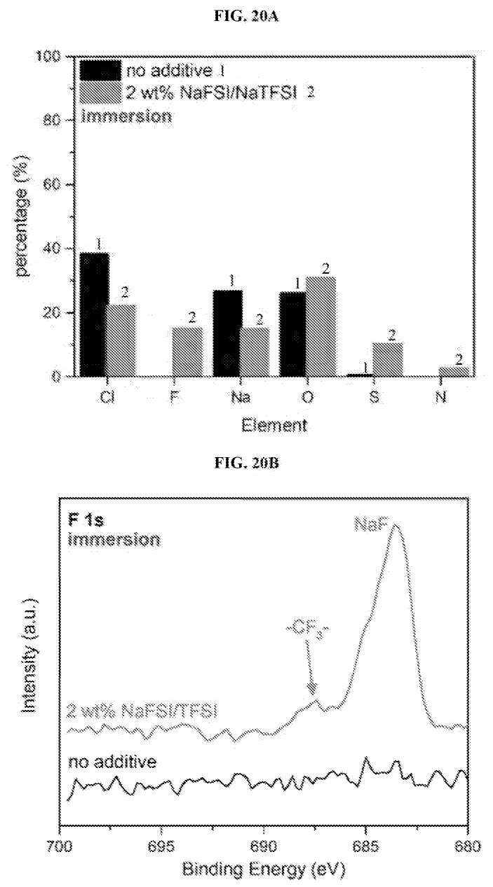

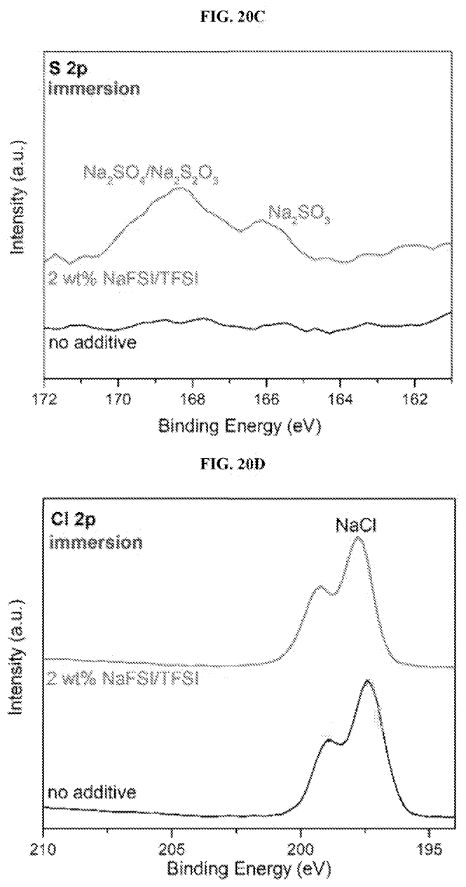

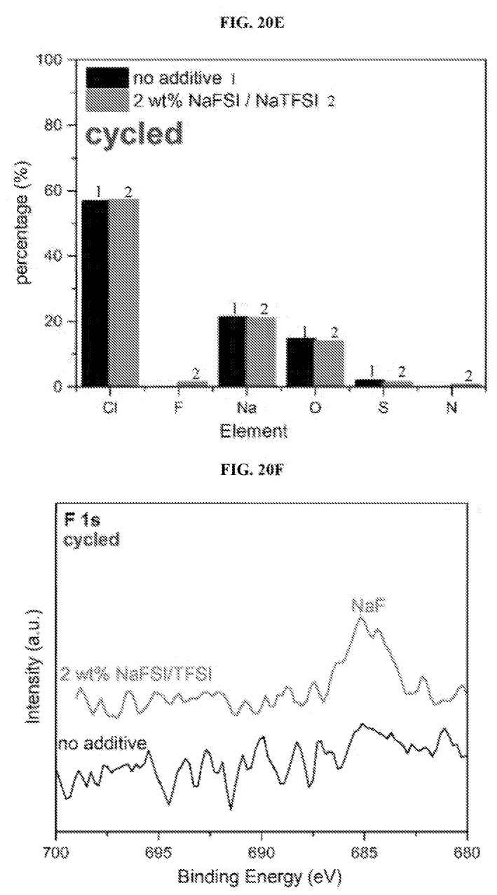

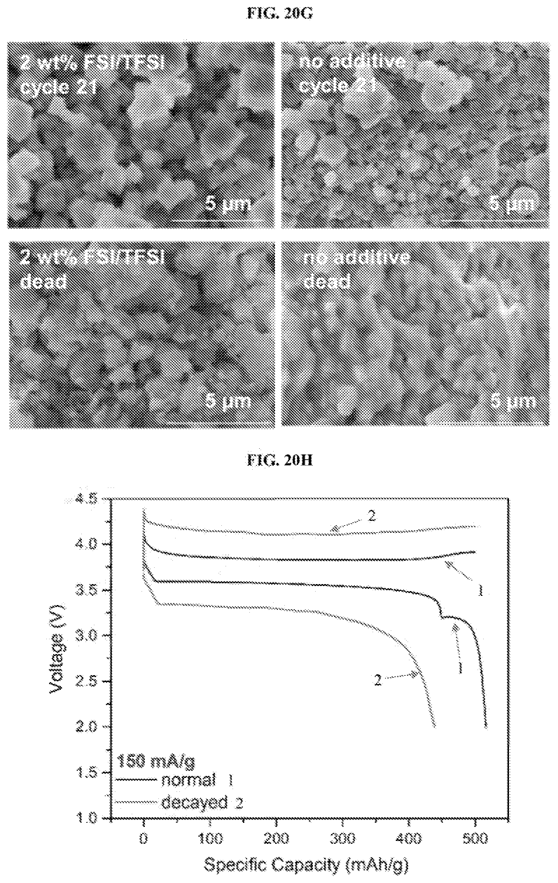

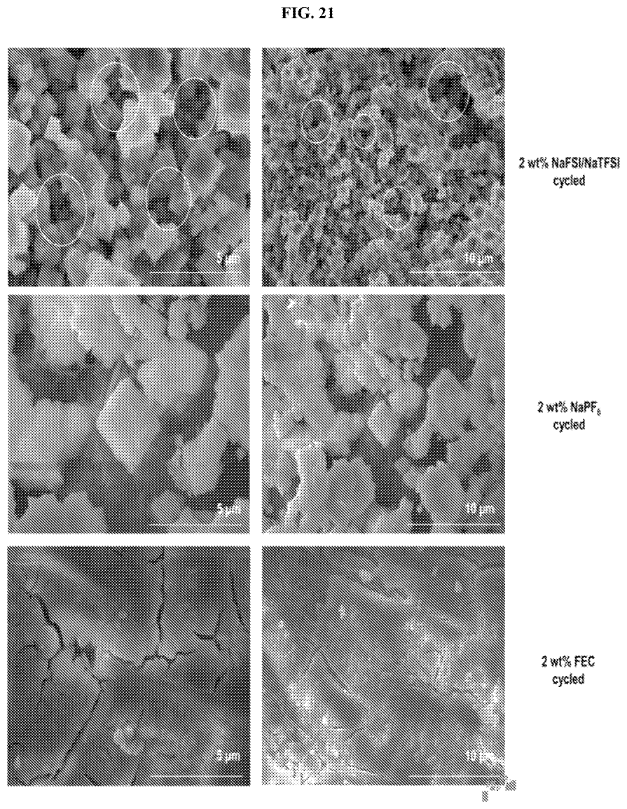

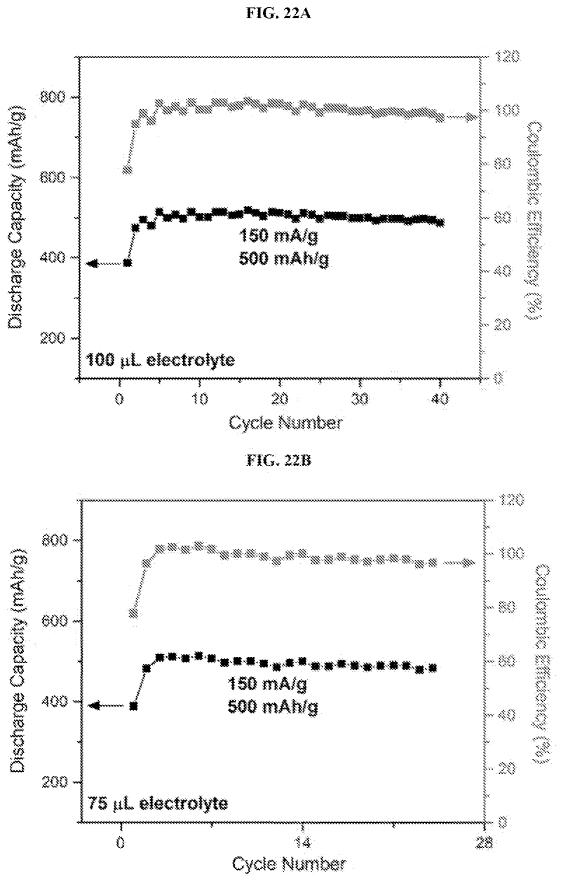

Various electrolyte additives (no additive, NaFSI, NaFSI +NaTFSI, NaPF₆, and FEC) were investigated and it was found that the mixed 2 wt % NaFSI and 2 wt % NaTFSI afforded the best cycling performance (FIGS. 4A-4B, FIGS. 19A-19B). The main component in the SEI layer was NaCl, formed as soon as the Na electrode was in contact with the electrolyte regardless of the additives added (FIGS. 19C-19D, and FIGS. 20A and 20D). Since NaCl layer was impermeable to Nat, the Na/Nat redox through the SEI layer for reversible Na deposition and stripping was attributed to cracks and void regions of the SEI that were sufficiently thin, NaF enriched and Na ion permeable.^{30,31} XPS and SEM showed that fluoride-containing additives in the electrolyte indeed afforded voids on the Na anode, with the mixture of NaF SI and NaTFSI additives giving the highest fluoride contents (NaF and —CF₃—) in the SEI (FIGS. 19C and 19E, and FIG. 20B). Over battery cycling, the fluoride content on Na surface decreased with increased NaCl (FIGS. 19C, 19G, and 19H, and FIGS. 20A, 20E, and 20F), and with electrolyte containing the optimal additives, the NaCl crystallites formed on the Na anode were the smallest in sizes with the highest number of voids, corroborating with reversible Na⁺/Na redox and the longest battery cycle life (FIG. 20G, and FIG. 21, Example 18). This is consistent with the SEI on alkali metal anode was more robust when both FSP⁻ and TFSI⁻ anions were present, as TFSI⁻ was less reactive and reacted with Na slower than FSP⁻, allowing a more uniform and robust SEI to form on the alkali metal anode^{14,32,33}.

The carbon nanospheres (aCNS) used for the positive electrode held a key to rechargeable Na/Cl₂ battery due to the high surface area (3167.82 m²/g) and high porosity (2.49 cm³/g), especially high micro-porosity (1.33 cm³/g, FIG. 24). Several widely used amorphous carbon materials including acetylene black (AB) and ketjenblack carbon black (KJ) were compared as positive electrode (FIG. 4C). The AB material showed the lowest surface area and pore volume (FIG. 24), giving the lowest first discharge capacity and cycle life (FIG. 4C). Compared to aCNS, the KJ material exhibited a lower surface area but larger pore volume (micro+meso pores=3.09 cm³/g, FIG. 24), affording a higher first discharge capacity (about 3250 mAh/g vs. about 2810 mAh/g). The increase in discharge capacity with increase in pore volume (KJ>aCNS >AB) in the positive electrode suggested that the high discharge capacity of the battery was owed to sustained NaCl discharge product filling the abundant micro- and meso-pores in the electrode (not due to surface NaCl coating, see Example 16 for detail)8′9′34′35. On re-charging, regions of the surface NaCl coating were oxidized/removed to expose the underlying nanospheres (see SEM in FIG. 2B inset, FIG. 15B) with a large impedance decrease (FIGS. 16B-16C), allowing oxidation of NaCl residing in the pores of nanospheres to release the majority of capacity stored in the lower plateau of the first discharge.

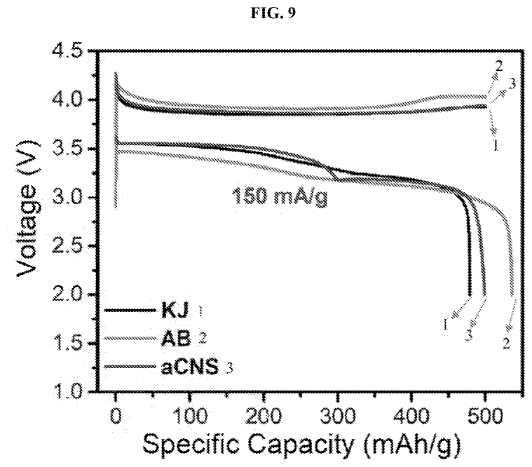

The aCNS positive electrode afforded Na/Cl₂ cells with coulombic efficiency and cycling stability (>200 cycles, FIG. 17A) superior to cells with KJ (about 50 cycles, FIG. 4C) or AB positive electrode (about 20 cycles, FIG. 4C). Despite a lower total pore volume than KJ, aCNS cycled more stably than KJ, pointing to the importance of the >60-fold higher micropore volume of aCNS (about 53.4% micropores in aCNS, about 1.33 cm³/g vs. only about 0.7% micropores in KJ about 0.021 cm³/g) (FIG. 24) to Na/Cl₂ battery cycle life. The much greater micropore volume in aCNS likely stabilized battery cycling by better retaining Cl₂, preventing excessive oxidizers in the electrolyte and anode corrosion (FIG. 9). Developing carbon materials with further improved micropore volume could further boost the capacity and cycling stability of secondary Na/Cl₂ batteries.

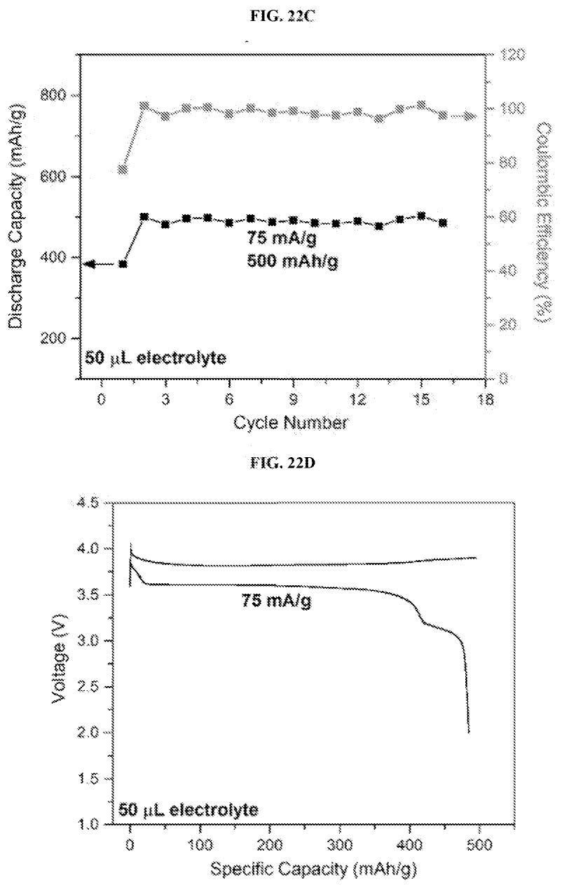

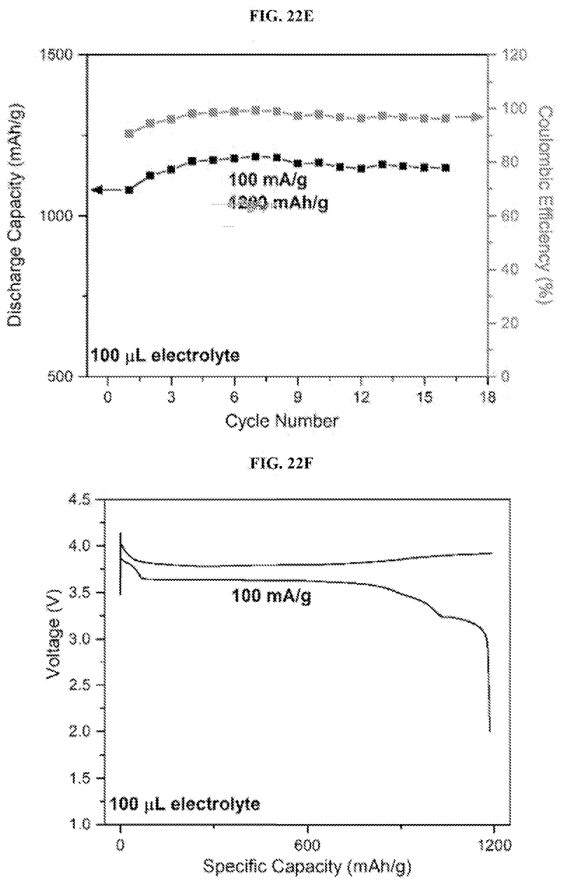

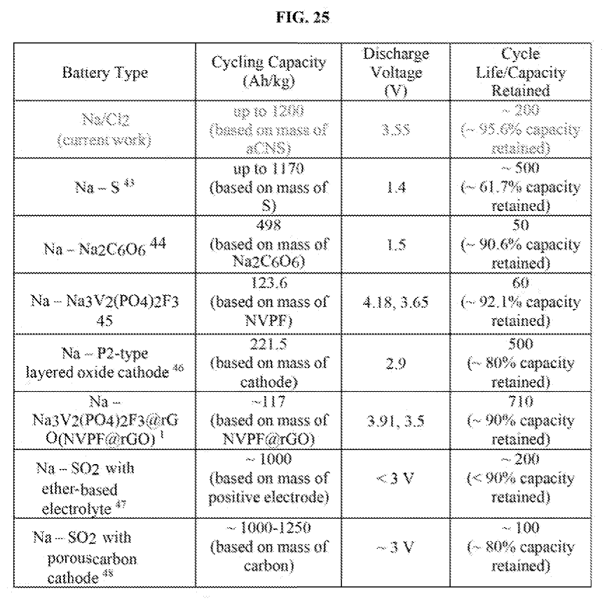

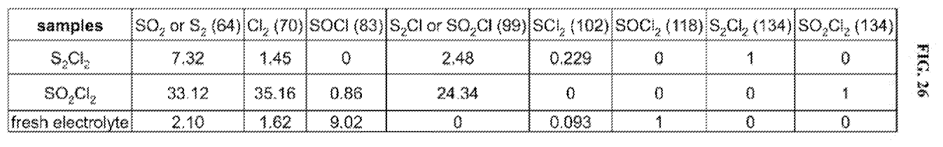

The Na/Cl₂ battery was used to light up a light-emitting diode (“LED”) that required an operating voltage of 3.0 V-3.2 V. The current measured through the LED was about 12.03 mA with a high current density of 6.14 mA/cm² of Na, equivalent to a discharge rate of 1563.35 mA/g (based on aCNS mass). Although the Na/Cl₂ battery is promising in voltage, specific capacity, cycle life, and capacity retention compared to various Na metal anode batteries (FIG. 25), optimization and engineering are needed for real-world use^{14,36-41}. Reducing the amount of electrolyte and using thin separators down to 60 μm were explored (FIG. 22). The batteries cycled well with increased gravimetric/volumetric energy density when the electrolyte volume was lowered to 100 μL and 50 μL, respectively.

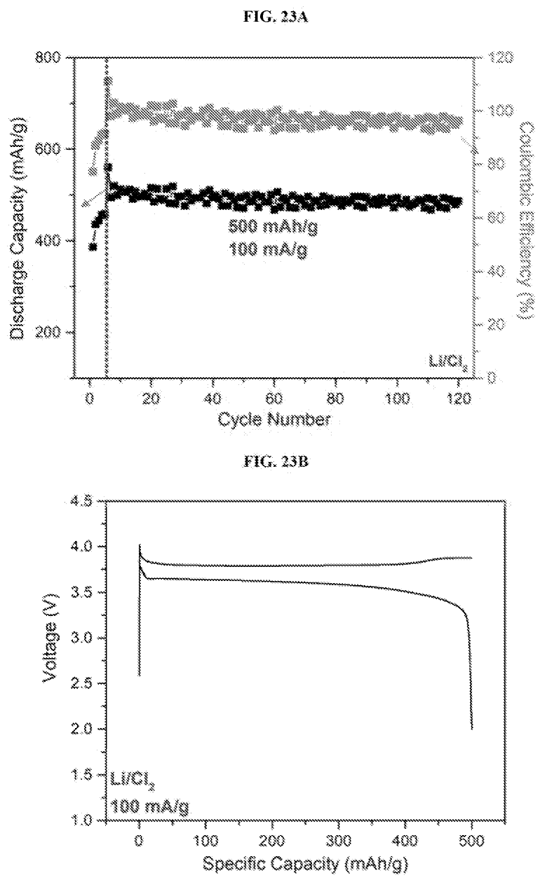

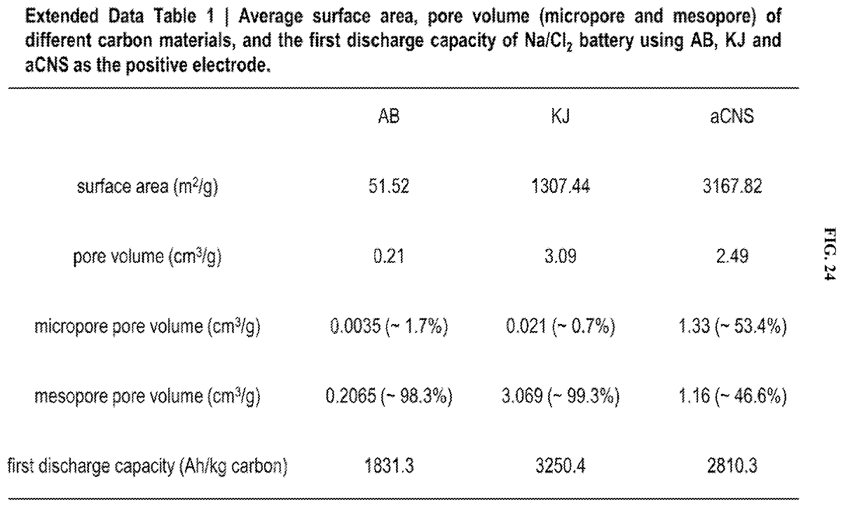

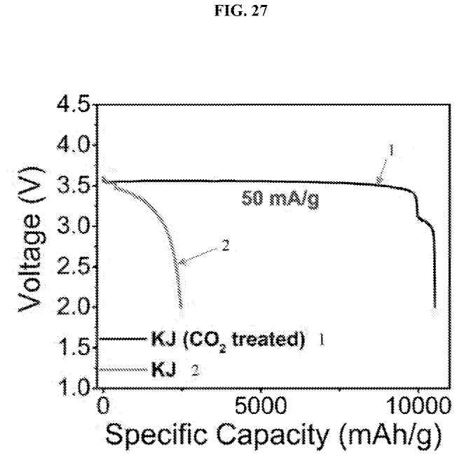

The Na/Cl₂ battery concept was extended to rechargeable Li/Cl₂ batteries by pairing the aCNS positive electrode with a Li metal as the negative electrode in electrolytes comprised of 1-4 M AlCl₃ in SOCl₂ with 2 wt % LiFSI/LiTFSI (Na was focused in this work due to chronical order of the research). The battery delivered about 3309 mAh/g first discharge capacity and was cyclable at 500-1200 mAh/g (150 mA/g and 100 mA/g currents) with the charging voltage at about 3.80 V and the discharging voltage at about 3.6 V (FIGS. 4E-4F and FIGS. 23A-23B). Despite the similarity, the differences between Li/Cl₂ and Na/Cl₂ batteries warranted further investigation. In terms of practical applications, the Li metal batteries could be more advantageous due to higher processability and lower reactivity than Na metal. In addition, first discharge capacity comparison between Li/Cl batteries when the positive electrode was KJ carbon and KJ carbon heat-treated in CO₂ was made. A substantial improvement in the first discharge capacity was seen after the KJ was heat treated in CO₂ (FIG. 27). Heat treatment of the KJ carbon in CO₂ gave it the desired microporosity.

Example 3. Synthesis of aCNS. 50 mL of deionized water and 20 mL of ethanol (>99.9%, J.T. Baker) were mixed uniformly at room temperature. 0.25 g of triblock copolymer, F-127 (PEO106-PPO70-PEO106, MW: 14600, Aldrich), was then added in the mixture and stirred for about 10 minutes. After F-127 dissolved completely, 0.5 g of ammonia solution (25%, Choneye, Taiwan) was then added in the solution and stirred for about 30 minutes followed by adding 0.5 g of resorcinol (99%, Alfa Aesar) into the solution. Finally, 0.763 g of formaldehyde solution (37 wt %, Aldrich) was added gradually into the solution and stirred for 24 hours at room temperature. The solution was centrifuged with 14,900 rpm to separate the solid and liquid. The solid was dried at 100° C. in oven and heated at 350° C. for 2 hours in N₂ to remove the template. The carbonization process was conducted at 800° C. for 4 hours in N₂ followed by the activation process using CO₂ at 1000° C. for 45 minutes.

Example 4. Characterization of carbon materials. AB was commercially available acetylene black (Soltex, Acetylene Black 50%-01) and KJ was commercially available Ketj en black carbon black(Ketj en black EC-600JD). pH was measured by dissolving 1 g of the carbon into 30 mL deionized water. The solution was then transferred into a round bottom flask and boiled under reflux for 5 minutes. After 5 minutes of boiling, the round bottom flask was removed from the heat source and allowed to cool down to room temperature. After all the carbon particles has sunk to the bottom of the round bottom flask, the pH of the clear liquid at top was measured. Brunauer-Emmett-Teller (BET) surface area and pore volume were measured by a 2020 Accelerated Surface Area and Porosimetry System from Micromeritics. Before each measurement, the appropriate amount of carbon (about 0.14 g) was weighed and placed in the instrument for degas at (350° C.). After degassing, the weight of the carbon was measured again and this weight was input into the software for final surface area and porosity analysis. In the final analysis, the evacuation time was set to be (6 hours) and dose amount was set to be (10 cm³/g STP). After the measurement was done by the instrument, the surface area and porosity were reported. Volatile % was measured using a high gravimetric sensitivity thermogravimetric analysis (TGA) instrument. The initial weight of the carbon samples was measured before introducing the samples into the TGA instrument. Then the temperature of the instrument was increased to 80° C. in 5 minutes and held at 80° C. for 10 minutes. After the 10 minutes isothermal step, the temperature was increased to 160° C. in 8 minutes and then held at 160° C. for 10 minutes. The final weight of the carbon was measured and the volatile % of the carbon was equal to the percent difference between the initial weight and the final weight.

Example 5. Fabrication of aCNS electrode. 90% by weight of aCNS and 10% by weight of polytetrafluoroethylene (60% aqueous PTFE dispersion, FuelCellStore) were mixed in 100% ethanol (Fisher Scientific). The mixture was sonicated for 2 hours until the aCNS was uniformly dispersed in ethanol. Ni foam substrate was cut into circular shape with diameter of 1.5 cm using a compact precision disc cutter (MTI, MSK-T-07). The circular Ni foam substrate was sonicated in 100% ethanol for 15 minutes and dried in an 80° C. oven until all the ethanol evaporated. The weight of the Ni foam substrate was measured and then placed to hover over a hot plate. The aCNS, PTFE and ethanol mixture was then slowly dropped (180 μL each time) onto the Ni foam. Between each drop, approximately 4 minutes was waited for to allow all the ethanol from previous drop to evaporate fully. This process was repeated and stopped until the loading of the aCNS on Ni foam substrate was desirable (for lower and higher loading aCNS electrode, the loading was 2-3 mg/cm² and 4-5 mg/cm², respectively). The electrodes were then dried in an 80° C. oven overnight. After drying, the electrode was pressed using a spaghetti roller and the final weight of the electrode was measured. After calculating the weight of aCNS, i.e., final weight of the electrode minus initial weight of the Ni foam times 90%, the electrode was ready to be used in a battery.

Example 6. Electrolyte making. The electrolyte was made inside an argon-filled glovebox. NaFSI (TCI Chemical) and NaTFSI (Alfa Aesar) were dried at 100° C. vacuum oven overnight before use and stored in an argon-filled glovebox. Thionyl chloride (purified, Spectrum catalog # TH138) was used without any further purification. The appropriate amount of thionyl chloride liquid was added into a 20 mL scintillation vial (Fisher Scientific) and its weight was measured. 4 M aluminum chloride (Fluka, 99%, anhydrous, granular) were weighed and added to the thionyl chloride and stirred until all the aluminum chloride was fully dissolved. Then the appropriate amount of NaFSI and NaTFSI (2 wt % of the total weight of aluminum chloride and thionyl chloride) were added to the solution and stirred until both NaFSI and NaTFSI completely dissolved, after which the electrolyte was ready to be used. The electrolyte for Li/Cl₂ battery was made similarly to the electrolyte for Na/Cl₂ battery by replacing NaFSI and NaTFSI with LiFSI and LiTFSI (TCI Chemical).

Example 7. Battery making. All batteries were made inside an argon-filled glovebox. Sodium metal block (Sigma Aldrich) was dried using kimwipe (Kimberly-Clark ProfessionalTM Kimtech ScienceTM) to remove the mineral oil on the surface. Razor blade was then used to cut all sides of the Na block to expose the shiny Na metal. The sodium metal block was then placed inside a zip lock bag and pressed using a scintillation vial to make thin sodium foil. The sodium foil was then pasted onto the spacer in a coin cell. Any extra sodium was then removed, so that the sodium foil had the exact shape as the spacer and could be used as the negative electrode. aCNS loaded on Ni foam was used as the positive electrode. 2 layers of quartz fiber filters (Sterlitech, Advantec, QR-100) were used as the separators and were dried in 120° C. vacuum oven overnight before each use. The aCNS positive electrode was put in the middle of the SS316 positive coin cell case. 2 layers of QR-100 separators were then put on top of the aCNS positive electrode. 150 μL of the electrolyte (4 M AlCl₃ in SOCl₂+2 wt % NaFSI+2 wt % NaTFSI) were then added to wet the QR-100 separators. The Na negative electrode on spacer was then put on top of the separators, with Na foil directly facing the aCNS positive electrode. One piece of spring was put on top of the spacer. Lastly, one layer of PTFE foil was put on top of the spring and underneath the SS316 negative coin cell case to prevent corrosion from the electrolyte. After all the components of the coin cell were put together, the coin cell was pressed using a digital pressure controlled electric crimper (MTI, MSK-160E) with the pressure reading set to 9.23. Then the coin cell was taken out the glovebox and was tested using a battery tester from Neware, BTS80, Version 17.

To prepare Li negative electrode for Li/Cl₂ battery, Li metal foil (Sigma Aldrich) was polished using a file. Then the shiny Li metal was pasted onto the spacer and used as the negative electrode. The separator used for Li/Cl₂ battery was 1 layer of quartz fiber filter (Sterlitech Advantec, QR-200). Everything else in assembling Li/Cl₂ battery was the same as assembling Na/Cl₂ battery.

Example 8. Electrochemical Impedance Spectroscopy. The electrochemical impedance spectroscopy (EIS) of the battery was measured using a potentiostat/galvanostat (model CHI 760D, CH Instruments). The working electrode was connected to the aCNS positive electrode, and the counter and reference electrodes were connected to the sodium negative electrode. The initial voltage of the measurement was set to be the open circuit potential of the battery at the time of the measurement. The high frequency was lx 105 Hz and the low frequency was 0.01 Hz. The amplitude of the measurement was 0.005 V.

Example 9. Scanning Electron Microscope (SEM). SEM imaging was measured using Hitachi/S-4800 SEM instrument. To conduct SEM imaging on aCNS, aCNS powder was first stuck on the sample stage of SEM using double-sided conductive carbon adhesive tapes and the stage was then loaded into the SEM chamber for measurement. To conduct SEM imaging on electrodes in actual battery, the battery was first opened inside an argon-filled glovebox. The electrodes were taken out from the opened battery and transferred into the argon-filled antechamber of the glovebox. The electrodes were vacuumed and dried inside the antechamber for approximately 3 hours to remove any electrolyte trapped in them. After drying, the electrodes were transferred back into the glovebox and ready to be characterized. The samples were stuck onto the SEM sample stage using double-sided conductive carbon adhesive tapes and introduced into the SEM chamber for measurement. The sample was observed by SEM with 15 kV acceleration voltage of an electron beam at a pressure of 10⁻⁷ torr. A magnification of 200,000 could be achieved.

Example 10. Transmission Electron Microscopy (TEM). Transmission electron microscopy (TEM) imaging was conducted on a FEI EO Tecnai F20 G2 MAT 5-TWIN field transmission electron microscopy. To prepare samples for TEM imaging, 0.02 g aCNS was dispersed in 10 mL deionized water in a 20 mL scintillation vial (Fisher Scientific). The mixture was sonicated for 30 minutes until a uniform dispersion of aCNS was achieved. After sonication, one drop of the mixture was dropped onto a Cu TEM grid using glass dropping pipette. The grid was then placed inside a 100° C. oven for 3 days. After drying, the Cu TEM grid with aCNS sample was introduced into the TEM instrument operating at 200 kV for measurement.

Example 11. XPS Experiments. XPS measurement was conducted in SNSF facility, Stanford University and the XPS instrument used was PHI VersProbe 1. To conduct XPS on sodium immersed in different solutions, the sample preparation was done inside an argon-filled glovebox. Na foil was prepared the same way as preparing Na electrode in battery (Battery Making). After immersion in the appropriate solution, the Na foil was taken out from the solution and any liquid remaining on the surface was dried using kimwipes (Kimberly-Clark Professional™ Kimtech Science™). The antechamber of the glovebox was refilled with argon and the sample was transferred into the antechamber, in which the sample was vacuumed dried. After drying, the sample was transferred into the glovebox and was ready to be characterized by XPS. To conduct XPS on electrodes from battery, the sample preparation was the same as the sample preparation for SEM imaging. After sample preparation, the sample was clamped onto the XPS stage and was transferred into the main chamber of the XPS instrument for measurement. All the spectra reported were the spectra obtained after 20 nm argon ion sputtering to remove any possible surface contamination during sample handling.

Example 12. X-ray Diffraction. X-ray diffraction (XRD) was conducted on an X-ray diffraction system (Rigaku Miniflex 600 Benchtop) with Cu Ka radiation. The aCNS powder was put on the XRD sample stage and a razor blade was used to press the powder until a flat surface was obtained and the powder was uniformly and firmly distributed over the sample stage. Any extra powder was carefully removed from the sample stage. The sample stage was then transferred into the center of the XRD instrument for measurement. The start angle and the stop angle were set to be 5° and 90° , respectively, with the scan speed of 3° /min. To conduct XRD measurements of electrodes from battery, the sample preparation was the same as the sample preparation for SEM imaging, and XRD was performed after the samples were transferred out from glovebox into the XRD instrument.

Example 13. Brunauer-Emmett-Teller (BET) Surface Area and Porosity. Brunauer-Emmett-Teller (BET) surface area and pore volume were measured by 2020 Accelerated Surface Area and Porosimetry System from Micromeritics. Before each measurement, the appropriate amount of carbon (about 0.14 g) was weighed and placed in the instrument for degas at 350° C. After degassing, the weight of the carbon was measured again and this weight was input into the software for final surface area and porosity analysis. In the final analysis, the evacuation time was set to be 6 hours and dose amount was set to be 10 cm³/g STP. After the measurement was done by the instrument, the surface area, porosity including microporosity and mesoporosity were reported.

Example 14. Mass Spectroscopy Analysis of Chemical Compositions in Na/Cl₂ Battery Cells.

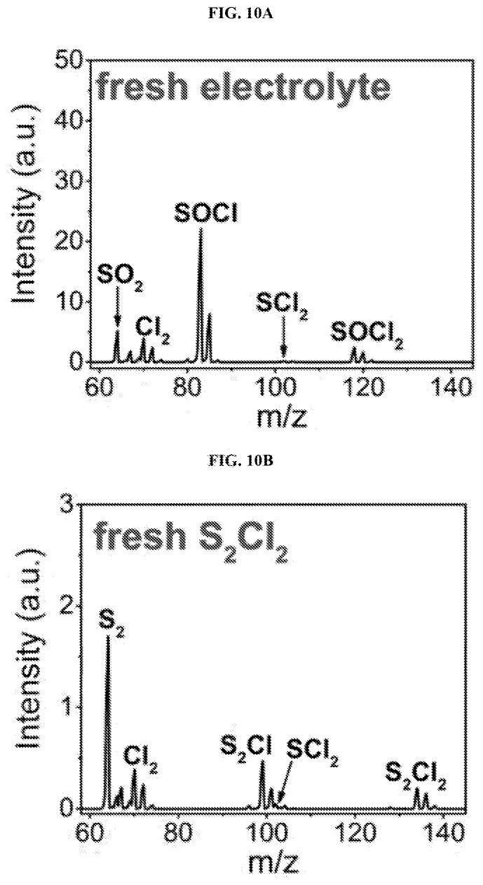

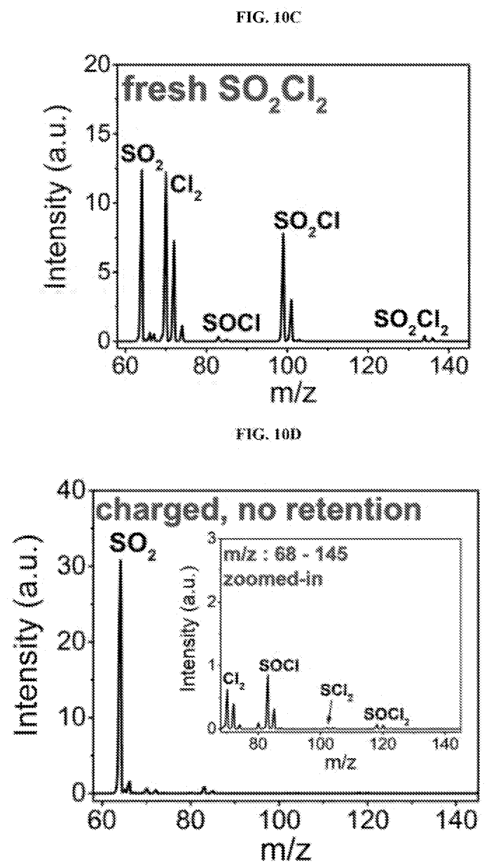

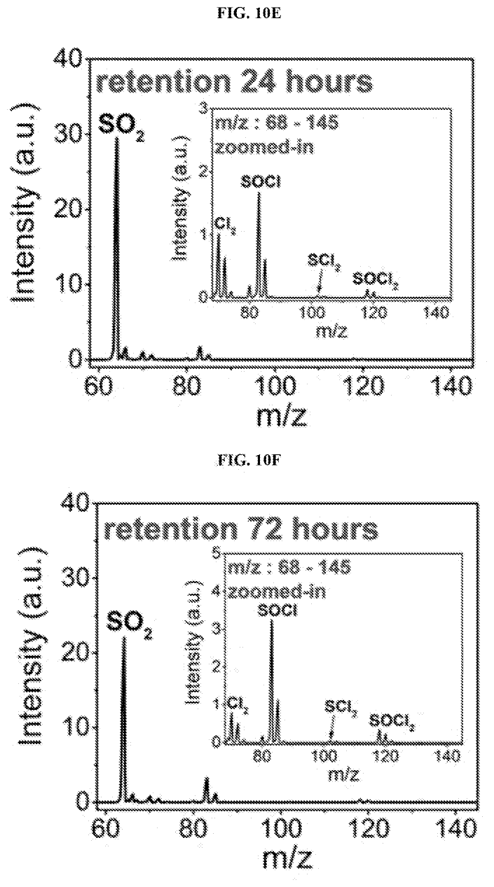

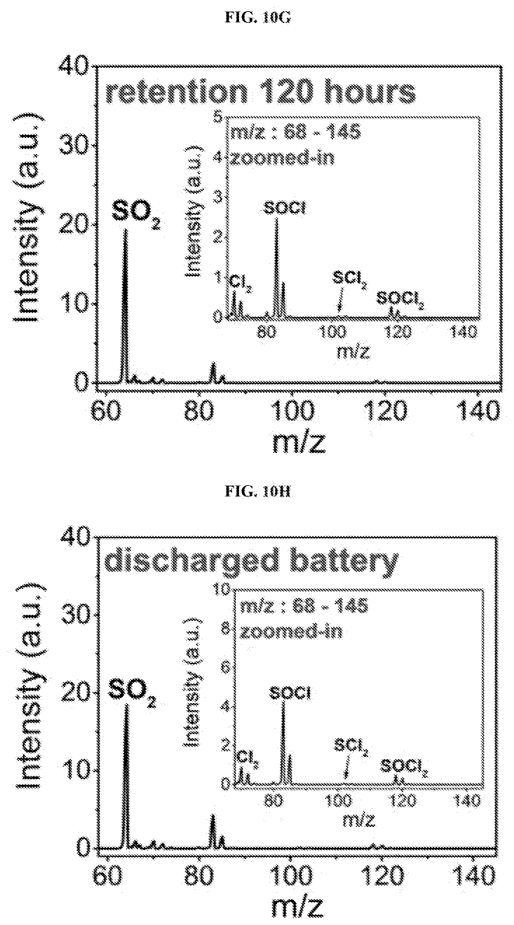

Instrument Setup and Measurement. The chemical compositions in a Na/Cl₂ coin cell battery were analyzed using a residual gas analyzer (RGA300) from Stanford Research System. Ions were generated by impact ionization known to generate fragments in addition to molecular peaks. When the battery reached the desire cycle number and charged or discharged state, the battery was opened inside an argon-filled glovebox and was immediately put into a Swagelok chamber with a closed Swagelok high vacuum valve attached. The chamber was then transferred outside of the glovebox and connected to the RGA300 setup. After opening the valve connecting between the chamber and the RGA300 instrument, the turbo pump would keep pumping to pull species in the opened battery in the chamber to the detector of the RGA300 instrument, and a mass spectrum of species from the battery was measured. After obtaining the opened battery mass spectrum at different battery states, each spectrum was normalized with respect to the argon peak at m/z=40 (Ar came from glovebox and normalized Ar peak intensity=100, FIGS. 10A-10H). The mass spectrum of fresh electrolyte (mostly SOCl₂, 4 M AlCl₃ in SOC12+2 wt % NaFSI+2 wt % NaTFSI), pure S₂Cl₂ and pure SO₂Cl₂ were also taken as the standard spectra (FIGS. 10A-10H). In each standard spectrum, the ratio between the peak intensity of any fragmented species (SO₂, Cl₂, SCl₂ etc.) and the molecular peak intensity (SOCl₂, S₂Cl₂ and SO₂Cl₂) was calculated (FIG. 26).

Quantitative Analysis of S₂Cl₂ and SO₂Cl₂. A peak at m/z=134 was detected inside the batteries after cycling, attributed to a combination of SO₂Cl₂ and S₂Cl₂ with the same molecular mass. SO₂Cl₂ and S₂Cl₂ also have a common fragment at m/z=99, corresponding to SO₂Cl and S₂Cl respectively. The intensity ratios between m/z=99 and the molecular peak at m/z=134 in standard spectra of SO₂Cl₂ and S₂Cl₂ respectively were calculated (FIG. 26) and compared with the measured ratio in a battery after cycling. The ratio of 4.03 between the m/z=99 and m/z=134 peaks detected in the cycled battery was in between 2.48 and 24.34 for pure SO₂Cl₂ and S₂Cl₂.Therefore, the peak at m/z=134 must be due to a mixture of SO₂Cl₂ and S₂Cl₂. To determine how much of each species was present in the cycled battery, the following equations was used to solve for the intensity of S₂Cl₂ and SO₂Cl₂:

Im/z=99=2.48×I_{S}_{₂}_{Cl}_{₂}+24.34×I_{SP}_{₂}_{CL}_{₂} (1)

Im/z=134 =I_{S}_{₂}_{Cl}_{₂}+I_{SO}_{₂}_{Cl}_{₂} (2)

In equation 1 and equation 2, Im/z=99 and Im/z==134 were the peak intensities at m/z=99 and m/z=134 detected in the cycled battery respectively. We then solved for I_{S}_{₂}_{Cl}_{₂} and I_{SO}_{₂}_{Cl}_{₂} that were the peak intensity or relative abundance of S₂Cl₂ and SO₂Cl₂, respectively.

Determination of Molecular Fragments Detected by Mass Spectroscopy in Batteries. After determining the mass-spec peak intensities of S₂Cl₂ and SO₂Cl₂, the ratios in FIG. 26 were used to determine the peak intensity of fragments due to different species in the battery, i.e., SOCl₂, S₂Cl₂ and SO₂Cl₂. For example, the Cl₂ fragment from these molecular species could be determined by:

I_{fragmented, Cl}_{₂}1.62 ×I_{SOCl}_{₂}+1.15×I_{S}_{₂}_{Cl}_{₂}35.16×I_{SO}_{₂}_{Cl}_{₂} (3)

In equation 3, I_{fragmented,Cl}_{₂} was the measured intensity of Cl₂ fragments from SOCl₂, S₂Cl₂ and SO₂Cl₂ in the cycled battery cell. I_{SOCl}_{₂}, I_{S}_{₂}_{Cl}_{₂}, I_{SO}_{₂}_{Cl}_{₂} were the measured peak intensity of SOCl₂, S₂Cl₂ and SO₂Cl₂ respectively in the same experiment. Similar calculation could be done for other fragments. For a given species, if its detected intensity was greater than that of fragments added up from larger molecules in the battery, then the extra intensity must be due to the generation of ‘free molecular species’ over battery operation. It was also realized that the peak ratio between SOCl (m/z=83) to SOCl₂ (m/z=118) would slightly change as the pumping time changed, resulting in slight change of the peak ratios between fragmented species to SOCl₂. Therefore, when calculating the fragmented intensity of any species contributed by SOCl₂, it was made sure that the actual spectrum had similar 83/118 ratio as in the standard SOCl₂ spectra.

Determination of Free Molecular Cl₂ Species Generated over Battery Cycling. To determine whether Cl₂ was generated over battery operation, the fragmented peak intensity of that species was first calculated by using equation 3. Then the difference between the actual peak intensity and the fragmented peak intensity was calculated. For example, the amount of free Cl₂ could be calculated by:

I_{freeCl}_{₂}=I_{actual,Cl}_{₂}−I_{fragmented,Cl}_{₂} (4)

In equation 4, I_{actual,Cl}_{₂} was the actual peak intensity of Cl₂ and I_{fragmented,Cl}_{₂} was the fragmented peak intensity of Cl₂ obtained from equation 3. Such difference reflected the amount of Cl₂ generated in the system.

Data Analysis and Interpretation for FIGS. 2E-2F. For each of the species reported in FIG. 2E and FIG. 2F (Cl₂, SO₂ and SO₂Cl₂), the amount of these species that are non-fragments in nature (‘free’ species, e.g., I_{free Cl}_{₂}, X hours retained) at different battery states (charged and then retained for 0 hour, 24 hours, 72 hours, or 120 hours and then discharged) were first calculated, and they were divided by the amount for the charged battery at 0 retention time (e.g., I_{free Cl}_{_{2,}} _{0 hour retained}). This ratio was shown in percentage for the y-axis of FIG. 2E and FIG. 2F. It was compared with the percentage of discharging plateaus retained at 3.55 V and 3.18 Vat the respective battery states in the same figure. For example, when analyzing Cl₂, the following two quantities would be compared and plotted in FIG. 2E:

$$\frac{{I}_{free {Cl}_{2} , 24 hours retained}}{{I}_{free {Cl}_{2} , 0 hour retained}}$$

$$versus$$

$$\frac{Capacity of 3.55 V plateau , 24 hours retained}{Capacity of 3.55 V plateau , 0 hour retained}$$

In the above two expressions, I_{free Cl}_{_{2,}}_{24 hour retained} and I_{free Cl}_{₂}_{, 0hour retained} were the amount of free Cl₂ determined from equation 4 when the battery retained at open circuit for 24 hours and 0 hour, respectively.

Data Analysis and Interpretation for FIG. 3A. Similarly, for any species of interest in the battery after stable cycling, the percent difference between the actual detected peak intensity and its peak intensity due to fragmentation of larger molecules could be calculated by:

$$percent difference = \frac{{I}_{actual} - {I}_{fragmented}}{{I}_{fragmented}} \times 100 \% \qquad ( 5 )$$

If in any battery state, the percent difference of a given species obtained from equation 5 was larger than 0, then there must be free species generated at that state. On the other hand, if the percent difference was close to 0, then all the peak intensity of that species in the spectrum was contributed by the fragmentations of SOCl₂, S₂Cl₂ and SO₂Cl₂ and no free species existed at that battery state. Such data was reported in FIG. 3a, in which how the amount of free Cl₂ and SCl₂ changed as the battery was either fully charged or fully discharged was analyzed.

### Example 15. Proposed Reactions During Battery Charge—Discharge

First Discharge of Na-amorphous carbon nanosphere (aCNS) battery. During first discharge, the initial electrolyte was highly acidic with 4 M AlCl₃ dissolved and the reaction happening at the higher discharge plateau (about 3.47 V, FIG. 1C of main text) was attributed to Na oxidation with the produced NaCl (from SOCl₂ reduction) reacting with AlCl₃ to neutralize the electrolyte by forming NaAl Cl₄:

4 Na+4 AlCl₃+2 SOCl₂→4 NaAlCl₄+S+SO₂ (6)

Through the high discharge plateau with about 950 mAh/g capacity discharged, the NaCl formed mostly dissolved in the electrolyte and few NaCl crystals were deposited to cover the electrode, as the morphology of packed aCNS nanospheres were still easily observed by SEM imaging (FIG. 1C inset, FIG. 15A).

As discharged progressed and the electrolyte turned to neutral (formation of NaAlCl₄, eq. 6), the reaction happened at the lower discharge plateau (about 3.27 V, FIG. 1C) was:

4 Na+2 SOCl₂→4 NaCl+S+SO₂ (7)

with the NaCl produced deposited into the micro- and meso-pores and on the surface of aCNS until discharge stopped (FIG. 1E inset, FIG. 1A, see Example 16 for detail), with the first discharge specific capacity of about 2800 mAh/g (based on aCNS mass).

Note that similar two-plateau discharge was observed in Li/SOCl₂ primary cells in initially acidic electrolytes^{1,2}. The proposed reactions eq. 6, 7 were also supported by the fact that when an initially neutral electrolyte of 4 M NaCl+4 M AlCl₃ in SOCl₂ was used, the higher plateau at about 3.47 V was not observed in the first discharge and only the plateau at about 3.25 V appeared throughout the whole discharge (FIG. 16D).

Charge-discharge of Na/Cl₂ battery. After the first discharge, the battery was subjected to charge-discharge cycling at a specified specific capacity in the range of 500-1200 mAh/g (first discharge capacity is about 2800 mAh/g) with >99% coulombic efficiency. During charging, the charging voltage spiked and then decreased, due to oxidative removal of NaCl coating on the aCNS that lowered the impedance of the battery (see FIG. 2A and FIGS. 15A-15C). NaCl oxidation was the main charging reaction along the charging plateau at about 3.83 V, and Cl₂ was formed during charging by the oxidation of Cl⁻ in NaCl according to the following reaction:

2 NaCl→2 Na⁺+Ch₂+2e⁻ (8)

This was the main reaction happened during Na/Cl₂ battery charging (main charging plateau at about 3.83 V). Near the end of this plateau, the charging voltage of the battery slightly increased to about 3.91 V, which suggested an additional oxidation reaction involving SOCl₂, and based on previous work on Li-SOCl₂ batteries, possible reactions proposed included³⁻⁵:

SOCl₂+AlCl₄⁻→SOCl+AlCl₄⁻⅓Cl₂+e⁻⁽9)

SOCl₂+AlCl₄⁻·SOCl⁺+2 AlCl₄⁻→SCl+ALCl₄⁻+SO₂Cl₂+Cl₂+2 AlCl₃+2e⁻ (10)

One of the products in eq. 10, SCl⁺AlCl₄⁻, was essentially a compound formed by SCl₂ complexing with AlCl₃. Another product in eq. 10, SO₂Cl₂, was also known to form from the chemical reaction between SO₂ (formed after 1st discharge, eq. 6, 7) and Cl₂ according to⁶:

SO₂+Cl₂ [symbol] So₂Cl₂ (11)

Eq. 11 could start to happen as soon as SO₂ and Cl₂ were both present in the system, and the longer a charged Na/Cl₂ battery was holding in open-circuit, the more dominant the reaction would be (FIG. 2D). At the same voltage (about 3.91 V), after enough Cl₂ was formed (eq. 8-10), S was well known to react with Cl₂ to form SCl₂, which could be further dissociated into S₂Cl₂ and Cl₂, according to the following reactions^{7,8}:

S+Cl₂→SCl₂ (12)

2 SCl₂⇄S₂Cl₂+Cl₂ (13)

The formation of SCl₂ was also confirmed by mass spectrometry as SCl₂ in the battery increased when fully charged and decreased to about 0 when the battery was discharged (FIG. 6A, see Example 14).

SCl₂ was known to undergo dissociation to form S₂Cl₂ and Cl₂ (equation 13) as previously reported (10, 16). In addition, S₂Cl₂ and Cl₂ could also be formed by SOCl₂ oxidation and SOCl₂ reaction with S according to the following reactions (27, 28):

4 SOCl₂→2 SO₂+S₂Cl₂+3 Cl₂ (13-1)

SOCl₂→SPCl³⁰ +½Cl₂+e⁻ (13-2)

2 SOCl₂+3 S→SO₂+2 S₂Cl₂ (13-3)

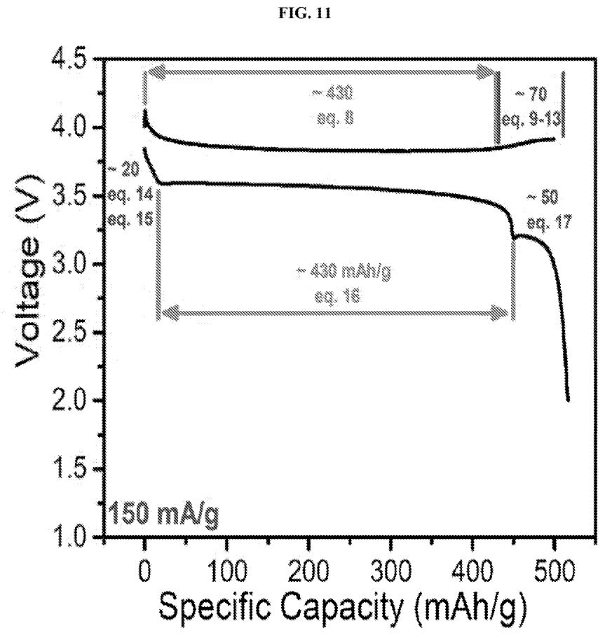

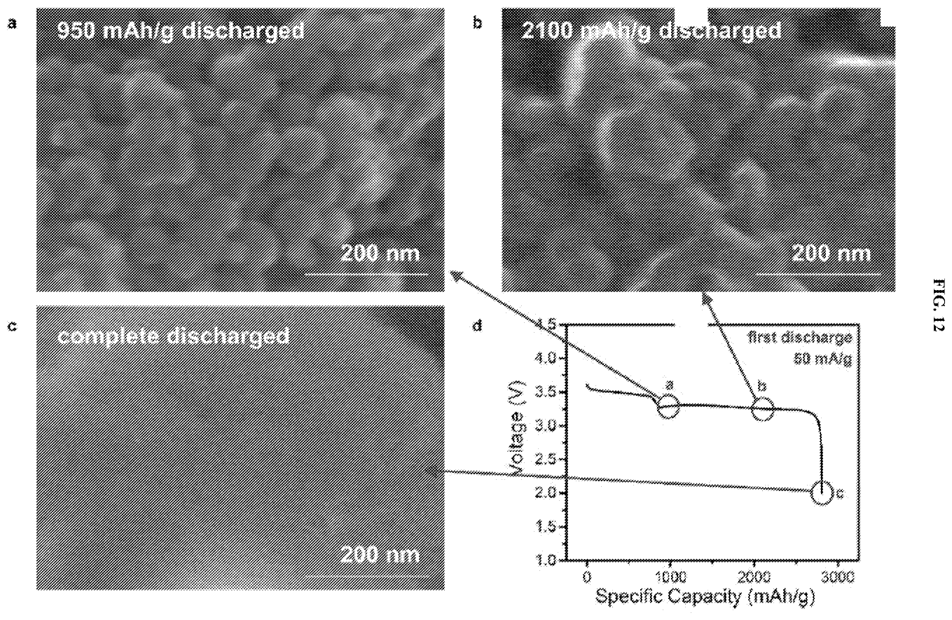

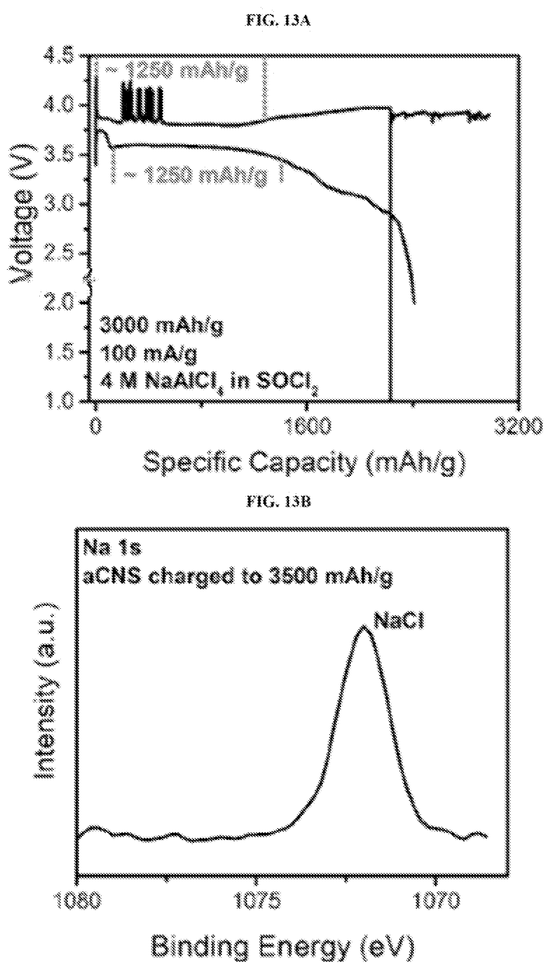

These reactions (eq. 8-13 and 13-1 to 13-3) led to the coexistence of Cl₂, SCl₂, SOCl₂, S₂Cl₂ and SO₂Cl₂ in the electrolyte when the battery was charged (FIG. 11).

During battery discharge, all the oxidation/charging products of the Na/Cl₂ battery (SCl₂, S₂Cl₂, Cl₂ and SO₂Cl₂) were reduced (FIG. 11). Their reduction reactions and corresponding voltages were^{3-6,9}:

2 Na⁺+SCl₂+2 e⁻→S+2 NaCl about 3.69 V (14)

2 Na⁺+S₂Cl₂+2 e⁻→2 S+2 NaCl about 3.69 V (15)

2 Na⁺+Cl₂+2 e⁻2 NaCl about 3.55 V (15)

2 Na⁺+SO₂Cl₂+2 e⁻→SO₂+2 NaCl about 3.18 V (17)

It was reported that SCl₂/S₂Cl₂ were generated and showed obvious reduction when oxidation scan passed 4.5 V vs. Li, with reduction voltage at 3.65 V-3.8 V vs. Li₃. Also, different studies on lithium/thionyl chloride cells reported that SO₂Cl₂ had a reduction potential about 0.35 V lower than Cl₂, which was consistent with the observation3.

The chemical compositions inside the Na/Cl₂ battery evolved in charged and discharged state, but over cycling at up to about 1200 mAh/g reversible capacity with CE>99%, the composition of the electrolyte was largely kept constant since the main redox reactions involving species of Cl₂, SCl₂, S₂Cl₂ and SO₂Cl₂ were reversible. During battery discharge, the oxidized SOCl₂ was regenerated when NaCl was produced and reacted with AlCl₄⁻·SOCl⁺ in the solution (see eq. 9), which was formed by combining SOC⁺ and AlCl₄⁻, by the following reaction:

NaCl+AlCl₄⁻·SPCl⁺→NaAlCa₂SOCl₂ (18)

This regeneration was important to the rechargeability of the Na/Cl₂ battery since it provides a source of SOCl₂ to sustain the reaction for the slightly increase charging plateau beyond the dominant, main NaCl oxidation plateau³. The reactions above led to reversibility of the chemical species in the Na/Cl₂ battery over cycling, and they are labeled in the charge-discharge curves in FIG. 11.

### Example 16. NaCl Filling Micropores of aCNS through First Discharge from SEM Images

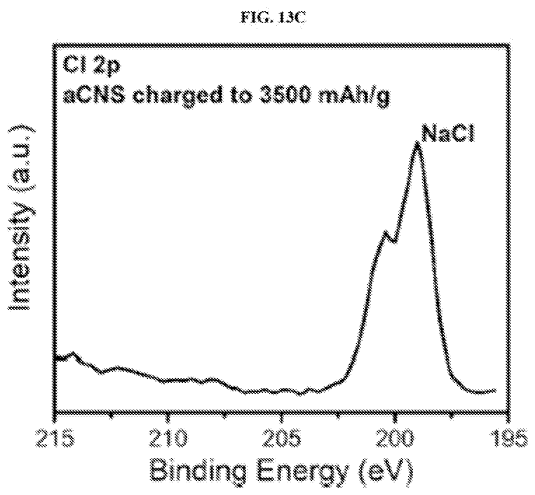

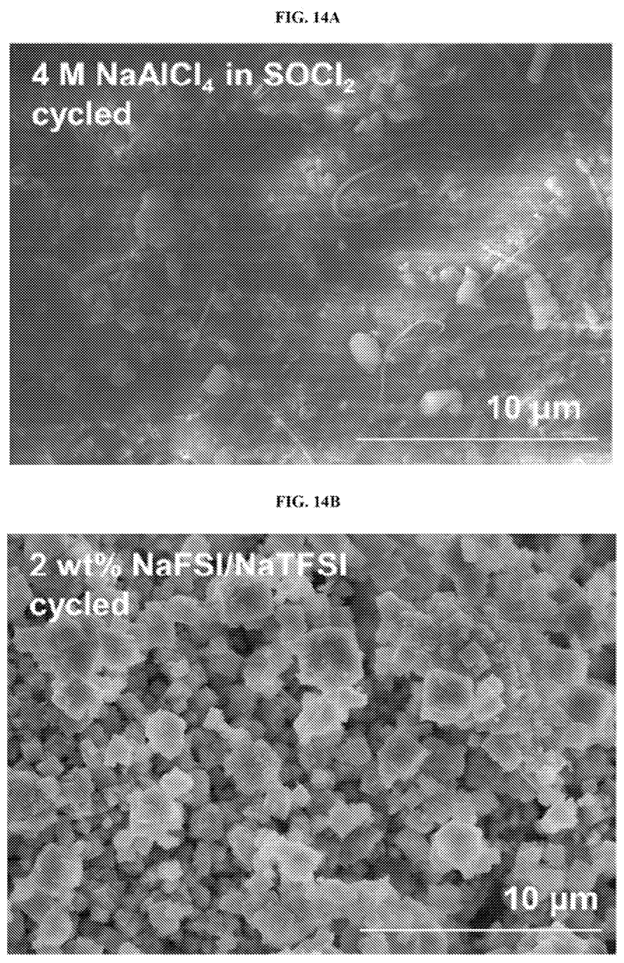

SEM images of aCNS at different battery stages through the first discharge (about 950 mAh/g discharge, about 2100 mAh/g discharge and full discharge) were also taken. From the SEM results, through the high voltage plateau of the first discharge, carbon nanospheres aCNS on the positive electrode could be clearly observed and obvious NaCl coating covering aCNS was not observed yet, since the NaCl produced dissolved in the electrolyte to neutralize AlCl₃ (FIG. 12, FIG. 15A) above including eq. 6 . When the battery was further discharged, the NaCl produced started filling the ultra-high pore volumes of aCNS (even at 2100 mAh/g discharged, nanospheres of aCNS in certain regions were still clearly observed without significant surface NaCl coating, as seen from SEM imaging, FIGS. 12A-2D) to afford a high capacity of about 2800 mAh/g with larger NaCl microcrystals (tens of microns in size) formed towards the end the discharge (FIG. 15A). When the first discharge was completed, SEM imaging no longer revealed any carbon nanospheres as they were coated by NaCl (FIG. 12C).

### Example 17. Full Rechargeability of Na/Cl₂ Battery and Effects of Neutral Electrolyte

It was found that during battery cycling, NaCl was the main species undergoing oxidation in charging, but not all the NaCl deposited on the aCNS electrolde through the first lower discharge plateau (the higher plateau corresponded to neutralization of the electrolyte without NaCl depsotion) at about 3.27 V (FIG. 1c) were oxidizable. aCNS charging has been characterized by XPS and SEM to 1860 mAh/g, which was the maximum capacity of the lower first discharge plateau with NaCl deposition on aCNS, and strong Na 1s and Cl 2p peaks was observed by XPS, indicating some NaCl still remaining on the aCNS surface (FIG. 3C-3D). From SEM imaging, uncoated carbon nanospheres in aCNS was observed, meaning that all the NaCl deposited on the surface and inside the pores were oxidized (FIG. 18 left image). Obvious NaCl microcrystals (>1 μm) were also observed either on top of the aCNS or in the gaps between aCNS clusters (FIG. 18 middle and right images). These NaCl microcrystals appeared to be weakly associated with the aCNS on the electrode surface and were not oxidizable. In contrast, NaCl deposited in the abundant pores of aCNS were electrochemically active to undergo highly reversible redox and contribute to the main reversible battery capacity during cycling. It was observed that when the charging capacity was 1860 mAh/g, the capacity corresponding to NaCl/Cl₂ redox was about 1250 mAh/g (about 70% of the lower first discharge plateau at about 3.27 V, FIG. 3B), and the coulombic efficiency was reduced to about 90%. The battery could cycle at a high capacity of about 1200 mAh/g with a high coulombic efficiency of >99%, with the charge-discharge curve maintaining its overall shape and the main about 3.83 V charge (NaCl oxidiation) and about 3.55 V discharge (Cl₂ reduction) plateaus simply extended their lengths and capacities (FIGS. 3E-3F, FIGS. 17B-17C). Cycling under further increased charge-discharge capacity was achievable with reduced coulombic efficiencies (about 95-96% for 1500 mAh/g cycling and about 90% for 1860 mAh/g cycling, FIGS. 3A-3B). The decrease in coulombic efficiency was due to that instead of oxidizing the remaining lossely associated NaCl on the aCNS surface, SOCl₂ was oxidized at a slightly higher overpotential which was less reversible (longer charging plateau >3.83 V and longer discharging plateau >3.55 V, FIG. 3B). Nevertheless, the Na/Cl₂ battey is fully rechargeable at a high capacity of about 1200 mAh/g with >99% CE. Further increasing the micropore volume by innovating carbon materials represents an important approach to further boost the reversible capacity of Na/Cl₂ batteries.

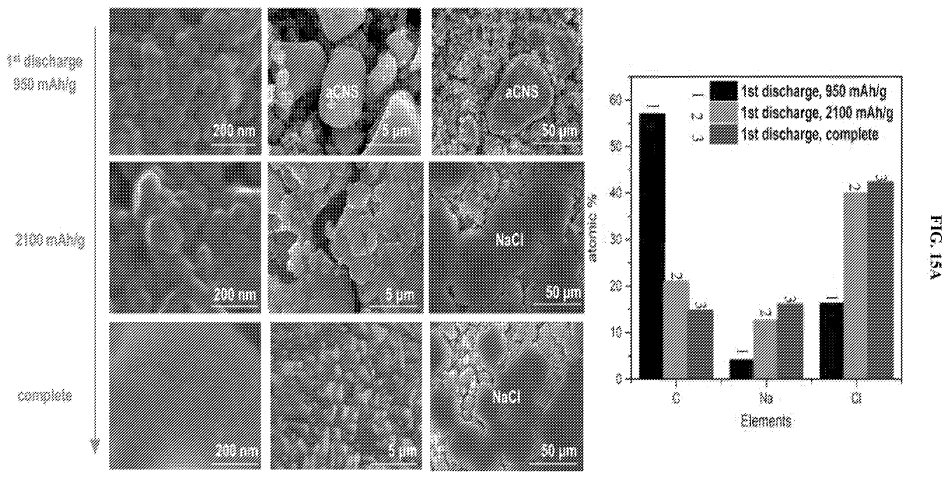

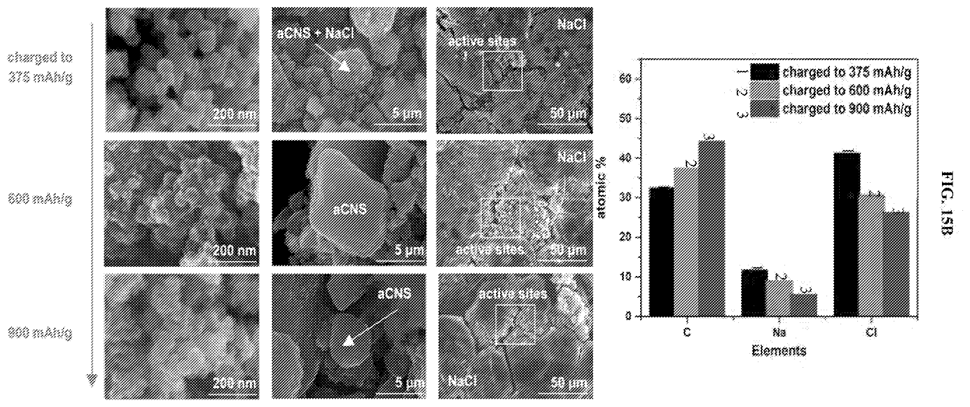

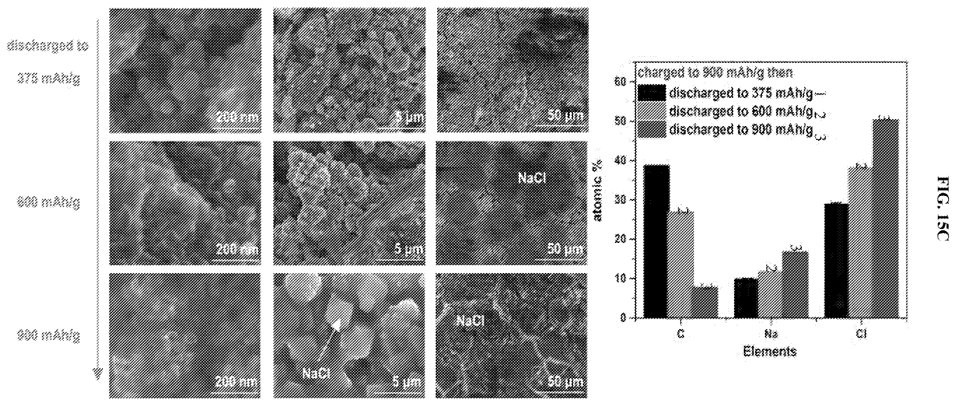

Pushing the cycling capacity limit of the battery will also require excellent protections to the Na electrode. Na/Cl₂ battery using neutral electrolyte, 4 M NaCl+4 M AlCl₃ in SOCl₂, had all its first discharge capacity of about 3500 mAh/g depositing NaCl on aCNS (FIG. 16D, where only one discharge plateau is observed without the one corresponding to electrolyte neutralization). However, when the battery was recharged at 3000 mAh/g (slightly less than the full first discharge capacity of 3500 mAh/g), the battery showed worse charge-discharge performance with unstable voltage during charging and a short cycle life (FIG. 13A). The aCNS electrode charging was characterized to 3500 mAh/g in neutral electrolyte using XPS and it was discovered that strong Na is and Cl 2p signals were also detected, indicating that as expected, parts of the deposited NaCl still remained on aCNS (FIGS. 13B-13C). Based on the charge-discharge curve at 3000 mAh/g, the capacity contributed by NaCl oxidation was also about 1250 mAh/g, again mainly corresponding to the NaCl deposited in the pores of aCNS (FIG. 13A), meaning that the remaining about 1750 mAh/g charging capacity was due to SOCl₂ oxidation and was not as reversible and led to excessive electrolyte composition change over cycling. A about 100% CE would be highly desired for high battery cycling stability and reversibility. Side products from low CE reactions led to excessive oxidizing species that could corrode the Na electrode. Indeed, SEM imaging of Na electrode after cycling in actual batteries showed that the SEI formed in neutral electrolyte had a uniform layer of NaCl that contained hardly any voids or cracks with thin F-rich SEI (observed with the highest performing acidic electrolyte with NaFSI and NaTFSI additives, FIG. 14B) through which reversible Na/Na⁺ redox could take place. Small crystallites of NaCl also grew on top of this layer (FIG. 14A). Such morphology made ions transports through the SEI difficult and was the reason why the battery charge-discharge behavior was inferior (FIG. 13A). In contrast, the SEI formed on Na electrode in 4 M AlCl₃ in SOCl₂+2 wt % NaFSI+2 wt % NaTFSI showed patches of square-shaped NaCl micro-crystals with abundant voids for efficient ions penetrations through the SEI layer (FIG. 14B). It was believed that this morphology was very important in allowing the NaCl coated Na anode to cycle efficiently. Excessive oxidation of the electrolyte and generation of highly oxidizing species would lower the coulombic effficiency of the battery, damaging the SEI on the Na anode, leading to unstable voltages observed with Na/Cl₂ cells cycling in neutral electrolyte (FIG. 13A).

### Example 18. Effects of Different Electrolyte Additives on SEI and Na/Cl₂ Battery Cycling

2 wt % NaFSI+2 wt % NaTFSI additive were compared to some commonly used additives in sodium batteries, fluoroethylene carbonate (FEC) and sodium hexafluorophosphate (NaPF6), and it was found that FEC giving little improvement in the Na/Cl₂ battery in cycling (FIGS. 19A-19B). XPS revealed that NaCl was formed on Na metal after immersing in electrolytes with these three additives (FIGS. 19C-19D, FIG. 20D). However, much more fluoride-based (—CF₃—, NaF, FIG. 20B) and sulfur-based components (Na₂SO₄, Na₂S₂O₃, and Na₂SO₃, FIG. 20C) were present in the SEI layer when the additive was a mixture of NaFSI and NaTFSI. Importantly, the Na anode SEI in electrolyte containing the NaFSI+NaTFSI mixed additives showed much higher NaF signal than in the electrolyte containing the NaPF₆ additive (FIG. 19C and 19E, FIG. 20B). No NaF was detected on Na anode immersed in the electrolyte containing FEC additive (FIG. 19E). With FEC a discernable CF signal was observed in Na anode SEI suggesting cleavage of FEC molecule to form CF without the formation of NaF. Since NaF is highly stable, the results here suggest that the Na anode SEI in electrolyte containing the NaFSI+NaTFSI mixed additives was the most robust afforded by the stable NaF to begin with in the beginning of the battery cycle life. Thick NaCl crystallites are not known to be permeable to Na⁺ or allow Na⁺ conduction, so it was believed that Na⁺ was transported through thin SEI layer in voids and cracks regions of the NaCl coated Na surface, and NaF component helped the stability of thin, and Na⁺ permeable SEI in such regions. After battery cycling, XPS revealed that the concentration of NaCl increased and NaF was also present in SEI for all three additives (FIGS. 19G and 19H, FIGS. 20E and 20F). When the additive was a mixture of NaF SI and NaTFSI, patches of loosely packed, square-shaped NaCl crystals were formed as the main SEI, and abundant voids and cracks in the SEI were observed (FIG. 21 top row). These voids were attributed to thin SEI regions that are rich in NaF, allowing Na-ion transport for Na stripping/depositing. The stability of such SEI regions on the Na anode could be key to Na/Cl₂ battery cycle life. Similar to the observation was Li anode film of Li/SOCl₂ battery, with cracks/voids between LiC1 particulates attributed to be responsible for sustained anode discharge through the first discharge to afford high capacity¹⁰.

In the electrolyte containing 2 wt % FEC, extended (tens of microns in size) and closely-packed NaCl crystals with few cracks were always observed, with a ‘blanket-like’ morphology, passivating/blocking the Na anode and affording the least Na reversibility and battery cycle life (FIG. 21 bottom row).

When the additive was 2 wt % NaPF₆, voids like morphologies and closely-packed, square-shaped NaCl were both observed (FIG. 21 middle row). The battery cycle life was improved over the FEC additive and no additive case, but shorter than the optimized electrolyte additive of 2 wt % NaFSI+2 wt % NaTFSI.

Also important was that the trend in surface morphology and SEI feature was in accordance with the trend in the battery's first discharge capacity using these three electrolyte additives, with 2 wt % FEC added electrolyte giving the lowest first discharge capacity (about 1979.52 mAh/g), followed by the 2 wt % NaPF₆ added electrolyte (about 2204 mAh/g), and the optimized 2 wt % NaFSI+2 wt % NaTFSI containing electrolyte (about 2810 mAh/g). This suggested that the Na anode was more rapidly passivated with NaCl coating when FEC was used as the additive, likely due to the lower ability to form the SEI stabilizing NaF phase when the -CF groups on FEC reacted with Na.

With electrolytes containing the NaFSI and NaTFSI types of additives, the Na/Cl₂ batteries still decayed eventually. The 2 wt % NaFSI/NaTFSI fluoride containing additives were found the best thus far to prolong the cycle life of the Na/Cl₂ battery due to the more robust solid electrolyte interphase (SEI) on the Na anode¹¹⁻¹⁵. Batteries with no additive showed poor cycle life (<50 cycles), and when only 2 wt % NaFSI was added, the battery cycle life improved to about 70 cycles but inferior to 2 wt % NaFSI/NaTFSI (FIG. 4A). XPS analysis revealed NaCl formation on Na anodes after simple immersion in electrolytes (4 M AlCl₃ in SOCl₂, with and without 2 wt % NaFSI/NaTFSI additives) due to reaction with SOCl₂ in both cases (FIGS. 6A and 6D). Only on Na electrode in the FSP and TFSI⁻ containing electrolyte were abundant elements of F, N and S, assigned to NaF, —CF₃, Na₂SO₄, Na₂S₂O₃, Na₂SO₃ observed, suggesting reactions between Na and both FR- and TFSI⁻anions to form a protective SEI layer on Na (FIGS. 20A-20C)^{16-20.} After battery cycling, the amount of NaCl on Na surface in both electrolytes (with and without 2 wt % NaFSI/NaTFSI) increased, with NaF still only present on Na in the electrolyte containing additives (FIGS. 20E-20F). SEM imaging showed that NaCl formed on the Na anode in the electrolyte with fluoride additives was in a less densely packed morphology than that formed without the additives (FIG. 20G). When both batteries reached the end of cycling life, more densely packed NaCl spherical particles on the Na anode, accompanied by a larger increase in electrochemical impedance, were observed (FIGS. 20G-20H). Overall, battery with FEC as the electrolyte additive showed the worst performance, indicating that forming —CF group alone on the SEI negatively affected the battery performance. Battery without any electrolyte additives showed improved performance, but was still worse than when fluoride-based additives were present in the electrolyte, with 2 wt % NaFSI+2 wt % NaTFSI being the best additive combination thus far. These results suggested that the fluoride additives forming NaF on SEI impeded rapid thickening of the passivating NaCl layer on the Na anode. The less dense surface NaCl packing indicated the existence of regions of Na metal underneath thin, F-rich SEI active for prolonged redox cycling.

In the Na/Cl₂ cell, the fluoride containing SEI on Na was formed in the first few cycles over which the coulombic efficiency increased to about 100% (FIG. 17A). Further investigation of strategies towards a more robust SEI layer could prevent or slow down irreversible Na reactions with corrosive species in the electrolyte including Cl₂, SOCl₂, SCl₂ and SO₂Cl₂.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

### REFERENCES

1 Venkatasetty, H. V. & Saathoff, D. J. Properties of LiAlCl4-SOCl₂ Solutions for Li/SOCl₂ Battery. Journal of The Electrochemical Society 128, 773-777, doi:10.1149/1.2127503 (1981).
2 Tsaur, K. C. & Pollard, R. Mathematical Modeling of the Lithium, Thionyl Chloride Static Cell: II . Acid Electrolyte. Journal of The Electrochemical Society 131, 984-990, doi:10.1149/1.2115788 (1984).
3 Istone, W. K. & Brodd, R. J. The Mechanisms of Thionyl Chloride Reduction at Solid Electrodes. Journal of The Electrochemical Society 131, 2467-2470, doi:10.1149/1.2115325 (1984).
4 Gangadharan, R., Namboodiri, P. N. N., Prasad, K. V. & Viswanathan, R. The lithium—thionyl chloride battery—a review. Journal of Power Sources 4, 1-9, doi: https://doi.org/10.1016/0378-7753(79)80032-4 (1979).
5 Madou, M. J. & Szpak, S. Investigation of SOCl₂ Reduction by Cyclic Voltammetry and AC Impedance Measurements. Journal of The Electrochemical Society 131, 2471-2475, doi:10.1149/1.2115326 (1984).
6 Bedfer, Y., Corset, J., Dhamelincourt, M. C., Wallart, F. & Barbier, P. Raman spectroscopic studies of the structure of electrolytes used in the Li/SOCl₂ battery. Journal of Power Sources 9, 267-272, doi: https://doi.org/10.1016/0378-7753(83)87027-X (1983).
7 Carter, B. J. et al. Mechanistic studies related to the safety of Li/SOC1/sub 2/ cells. J. Electrochem. Soc.; (United States), Medium: X; Size: Pages: 525-528 (1985).
8 Marinčić, N. Materials balance in primary batteries. II. Lithium inorganic batteries at high discharge rates. Journal of Applied Electrochemistry 6, 51-58, doi:10.1007/BF01058870 (1976).
9 Wang, D. et al. The Effects of Pore Size on Electrical Performance in Lithium-Thionyl Chloride Batteries. Frontiers in Materials 6, doi:10.3389/fmats.2019.00245 (2019).
10 Klinedinst, K. A. & Domeniconi, M. J. High Rate Discharge Characteristics of Li/SOCl₂ Cells. Journal of The Electrochemical Society 127, 539-544, doi:10.1149/1.2129708 (1980).
11 Abraham, K. M. & Mank, R. M. Some Chemistry in the Li/SOCl₂ Cell. Journal of The Electrochemical Society 127, 2091-2096, doi:10.1149/1.2129352 (1980).
12 Spotnitz, R. M., Yeduvaka, G. S., Nagasubramanian, G. & Jungst, R. Modeling self-discharge of Li/SOCl₂ cells. Journal of Power Sources 163, 578-583, doi:https://doi.org/10.1016/j.jpowsour.2006.09.025 (2006).
13 Morrison, M. M. & Marincic, N. Studies in lithium oxyhalide cells for downhole instrumentation Use of lithium tetrachlorogallate electrolyte in Li/SOCl₂ cells. Journal of Power Sources 45, 343-352, doi: https://doi.org/10.1016/0378-7753(93)800234 (1993).
14 Sun, H. et al. A safe and non-flammable sodium metal battery based on an ionic liquid electrolyte. Nature Communications 10, 3302, doi:10.1038/s41467-019-11102-2 (2019).
15 Sun, H. et al. High-Safety and High-Energy-Density Lithium Metal Batteries in a Novel Ionic-Liquid Electrolyte. Advanced Materials 32, 2001741, doi:10.1002/adma.202001741 (2020).
16 Zhu, G. et al. Rechargeable aluminum batteries: effects of cations in ionic liquid electrolytes. RSC Advances 9, 11322-11330, doi:10.1039/C9RA00765B (2019).
17 Lin, M.-C. et al. An ultrafast rechargeable aluminium-ion battery. Nature 520, 324-328, doi:10.1038/nature14340 http://www.nature.com/nature/journal/v520/n7547/ab s/nature14340 .html#supplementary-information (2015).
18 Angell, M. et al. High Coulombic efficiency aluminum-ion battery using an A1C13-urea ionic liquid analog electrolyte. Proceedings of the National Academy of Sciences 114, 834-839, doi:10.1073/pnas.1619795114 (2017).
19 Pan, C.-J. et al. An operando X-ray diffraction study of chloroaluminate anion-graphite intercalation in aluminum batteries. Proceedings of the National Academy of Sciences 115, 5670-5675, doi:10.1073/pnas.1803576115 (2018).
20 Di Lecce, D., Carbone, L., Gancitano, V. & Hassoun, J. Rechargeable lithium battery using non-flammable electrolyte based on tetraethylene glycol dimethyl ether and olivine cathodes. Journal of Power Sources 334, 146-153, doi:https://doi.org/10.1016/j.jpowsour.2016.09.164 (2016).
21 Agostini, M., Xiong, S., Matic, A. & Hassoun, J. Polysulfide-containing Glyme-based Electrolytes for Lithium Sulfur Battery. Chemistry of Materials 27, 4604-4611, doi:10.1021/acs.chemmater.5b00896 (2015).
22 Cai, K., Song, M.-K., Cairns, E. J. & Zhang, Y. Nanostructured Li2S—C Composites as Cathode Material for High-Energy Lithium/Sulfur Batteries. Nano Letters 12, 6474-6479, doi:10.1021/n1303965a (2012).
23 Angell, M., Zhu, G., Lin, M.-C., Rong, Y. & Dai, H. Ionic Liquid Analogs of AlCl₃ with Urea Derivatives as Electrolytes for Aluminum Batteries. Advanced Functional Materials 30, 1901928, doi:10.1002/adfm.201901928 (2020).
24 Barpanda, P., Oyama, G., Nishimura, S.-i., Chung, S.-C. & Yamada, A. A 3.8-V earth-abundant sodium battery electrode. Nature Communications 5, 4358, doi:10.1038/ncomms5358 (2014).
25 Zhu, C., Kopold, P., van Aken, P. A., Maier, J. & Yu, Y. High Power—High Energy Sodium Battery Based on Threefold Interpenetrating Network. Advanced Materials 28, 2409-2416, doi:10.1002/adma.201505943 (2016).
26 Liu, J. et al. Extension of The Stober Method to the Preparation of Monodisperse Resorcinol—Formaldehyde Resin Polymer and Carbon Spheres. Angewandte Chemie International Edition 50, 5947-5951, doi:10.1002/anie.201102011 (2011).
27 Tsai, C.-Y., Tai, H.-C., Su, C.-A., Chiang, L.-M. & Li, Y.-Y. Activated Microporous Carbon Nanospheres for Use in Supercapacitors. ACS Applied Nano Materials 3, 10380-10388, doi:10.1021/acsanm.0c02291 (2020).
28 Gross, S. & Society, E. Proceedings of the Symposium on Battery Design and Optimization. (Battery Division, Electrochemical Society, 1979).
29 Abraham, K. M., Mank, R. M. & Holleck, G. L. Investigations of the safety of Li/SOCl₂ batteries. (1979).
30 Dey, A. N. Lithium anode film and organic and inorganic electrolyte batteries. Thin Solid Films 43, 131-171, doi:https://doi.org/10.1016/0040-6090(77)90383-2 (1977).
31 Mogensen, M. B. & Henneso, E. Properties and Structure of the LiC1 -films on Lithium Anodes in Liquid Cathodes. Acta chimica Slovenica 63, 519-534, doi:10.17344/acsi.2016.2310 (2016).
32 Alvarado, J. et al. Bisalt ether electrolytes: a pathway towards lithium metal batteries with Ni-rich cathodes. Energy & Environmental Science 12, 780-794, doi:10.1039/C8EE02601G (2019).
33 Eshetu, G. G. et al. Ultrahigh Performance All Solid-State Lithium Sulfur Batteries: Salt Anion's Chemistry-Induced Anomalous Synergistic Effect. Journal of the American Chemical Society 140, 9921-9933, doi:10.1021/jacs.8b04612 (2018).
34 Evans, T. I., Nguyen, T. V. & White, R. E. A Mathematical Model of a Lithium/Thionyl Chloride Primary Cell. Journal of The Electrochemical Society 136, 328-339, doi:10.1149/1.2096630 (1989).
35 Gilman, S. The Reduction of Sulfuryl Chloride at Teflon-Bonded Carbon Cathodes. Journal of The Electrochemical Society 127, 1427, doi:10.1149/1.2129924 (1980).
36 Xu, X. et al. A room-temperature sodium—sulfur battery with high capacity and stable cycling performance. Nature Communications 9, 3870, doi:10.1038/s41467-018-06443-3 (2018).
37 Lee, M. et al. High-performance sodium—organic battery by realizing four-sodium storage in disodium rhodizonate. Nature Energy 2, 861-868, doi:10.1038/s41560-017-0014-y (2017).
38 Hu, L. et al. Dually Decorated Na3V2(PO4)2F3 by Carbon and 3D Graphene as Cathode Material for Sodium-Ion Batteries with High Energy and Power Densities. ChemElectroChem 7, 3975-3983, doi:https://doi.org/10.1002/celc.202000881 (2020).
39 Hwang, J.-Y., Kim, J., Yu, T.-Y. & Sun, Y.-K. A New P2-Type Layered Oxide Cathode with Extremely High Energy Density for Sodium-Ion Batteries. Advanced Energy Materials 9, 1803346, doi:https://doi.org/10.1002/aenm.201803346 (2019).
40 Liu, X., Ma, W., Lei, X., Zhang, S. & Ding, Y. Rechargeable Na—SO2 Battery with Ethylenediamine Additive in Ether-Based Electrolyte. Advanced Functional Materials 30, 2002120, doi: https://doi.org/10.1002/adfm.202002120 (2020).
41 Jeong, G. et al. A room-temperature sodium rechargeable battery using an SO2-based nonflammable inorganic liquid catholyte. Scientific reports 5, 12827-12827, doi:10.1038/srep12827 (2015).

1. An electrochemical device comprising:
an anode comprising sodium or lithium;
a cathode comprising a carbonaceous material;
a separator; and
an electrolyte comprising a metal halide, a fluorinated electrolyte compound, and thionyl chloride;
wherein the electrochemical device is a secondary battery.

2. The electrochemical device of claim 1, wherein the metal halide is AlCl₃, NaCl₁, LiCl₁, GaCl₃, or a mixture of any two or more thereof

3. The electrochemical device of claim 1, wherein the carbonaceous material is elected from the group consisting of amorphous carbon nanospheres, acetylene black, Ketjenblack, activated carbon, graphene, nanographene, graphene oxide, reduced graphene oxide, carbon foam, carbon fibers, graphite particles, nano-graphite particles, or a combination of any two or more thereof

4. The electrochemical device of claim 1, wherein the carbonaceous material is produced from heat-treating the carbonaceous material in the presence of CO₂ gas, water vapor, oxygen, air, or a combination of any two or more thereof.

5. The electrochemical device of claim 4, where the heat-treating is conducted at a temperature of at least 500° C., preferably 500 to 1100° C.

6. The electrochemical device of claim 1, wherein the carbonaceous material has a surface area of about 1000 m²/g to about 4000 m²/g, and a porosity of about 0.5-6 cm³/g.

7. The electrochemical device of claim 1, wherein the carbonaceous material is microporous and has a microporosity of at least 0.5 cm³/g, preferably at least 1 cm³/g.

8. The electrochemical device of claim 1, wherein the carbonaceous material is packed on a substrate of Ni or stainless steel foil or foam with or without a PTFE polymer binder.

9. The electrochemical device of claim 1, wherein the electrolyte comprises up to about 10 wt % of the fluorinated electrolyte compound.

10. The electrochemical device of claim 9, wherein the fluorinated electrolyte compound comprises an ammonium, alkyl ammonium, or alkali metal salt of a bis(oxalato)borate, dihalo(oxalate)borate, bis(fluorosulfonyl)imide, bis(trifluoromethane)sulfonimide, or a combination of any two or more thereof.

11. The electrochemical device of claim 1, wherein the anode comprises sodium.

12. The electrochemical device of claim 11, wherein the electrolyte comprises about 0.5 M to about 6 M AlCl₃ and 0 M to about 6 M NaCl in thionyl chloride.

13. The electrochemical device of claim 11, wherein the electrolyte comprises about 0.5 M to about 6 M GaCl₃ and 0 M to about 6 M NaCl in thionyl chloride.

14. The electrochemical device of claim 11, wherein the electrolyte comprises about 0 wt % to about 2 wt % sodium bis(trifluoromethane)sulfonimide, and about 0 wt % to about 8 wt % sodium bis(fluorosulfonyl)imide.

15. The electrochemical device of claim 1, wherein the anode comprises lithium.

16. The electrochemical device of claim 15, wherein the electrolyte comprises about 0 M to about 6 M lithium chloride (LiCl) and about 0.5 M to about 6 M AlCl₃ in thionyl chloride.

17. The electrochemical device of claim 15, wherein the electrolyte comprises about 0.5 M to about 6 M GaCl₃ and 0 M to about 6 M LiCl in thionyl chloride.

18. The electrochemical device of claim 15, wherein the electrolyte includes about 0 wt % to about 3 wt % lithium bis(fluorosulfonyl)imide.

19. The electrochemical device of claim 1, wherein the separator comprises a glass fiber paper, a quartz fiber paper, a porous glass membrane, a porous glass filter, a porous quartz membrane, a porous quartz filter, porous PTFE membranes or a combination of any two or more thereof.

20. The electrochemical device of claim 1, wherein the carbon material in the cathode is microporous and not purely mesoporous or macroporous.

21. The electrochemical device of claim 1, wherein the carbon material in the cathode is made by heating a carbonaceous material in the presence of CO₂ gas, water vapor, oxygen, air or a combination of any two or more thereof at a temperature sufficient to carbonize the solid and form porous carbon.

22. The electrochemical device of claim 1, wherein the secondary battery is functional down to about −80° C.

23. A method of producing a microporous carbon material, the method comprising:
reacting a block polymer having ethylene oxide and propylene oxide units with ammonia;
adding an aromatic diol and formaldehyde to form a solid; and
heating the solid in the presence of CO₂ gas, water vapor, oxygen, air, or a combination of any two or more thereof at a temperature sufficient to carbonize the solid and form the microporous carbon material.

24. The method of claim 23, wherein the temperature sufficient to carbonize the solid is at least 500° C., preferably 500 to 1100° C.

25. The method of claim 23, wherein the microporous carbon material have a surface area of 1000-4000 m²/g, and a porosity of at least 0.5 cm³/g.

26. The method of claim 23, wherein the microporous carbon material exhibits a microporosity of at least 0.5 cm³/g, preferably at least 1 cm³/g.

27. A microporous carbon material produced by the method of claim 22.

28. A microporous carbon material exhibiting a microporosity of at least 0.5 cm³/g, preferably at least 1 cm³/g.
